(19) United States
(12) Patent Application Publication
(10) Pub. No.: US 2025/0193701 A1
(43) Pub. Date: Jun. 12, 2025

(54) METHOD AND APPARATUS FOR DATA TRANSMISSION BASED ON FUNCTIONAL SPLIT BASE STATION

(71) Applicant: ELECTRONICS AND TELECOMMUNICATIONS RESEARCH INSTITUTE, Daejeon (KR)

(72) Inventors: Jun Sik KIM, Daejeon (KR); Young Jo KO, Daejeon (KR); Kwang Seon KIM, Daejeon (KR); Soon Gi PARK, Daejeon (KR)

(73) Assignee: ELECTRONICS AND TELECOMMUNICATIONS RESEARCH INSTITUTE, Daejeon (KR)

(21) Appl. No.: 18/940,104

(22) Filed: Nov. 7, 2024

(30) Foreign Application Priority Data
Dec. 7, 2023 (KR) 10-2023-0176734
Sep. 27, 2024 (KR) 10-2024-0131911

(51) Int. Cl. H04W 24/02; H04W 76/10; H04W 76/20; H04W 76/30

(52) U.S. Cl. CPC H04W 24/02; H04W 76/10; H04W 76/20; H04W 76/30

(57) ABSTRACT

Various embodiments related to data transmission technology using functional split base stations are disclosed. In one embodiment, a method of operating a first central unit-control plane (CU-CP) implemented by an electronic device in a functional split base station system comprising a plurality of distributed units (DUs), a plurality of central unit-user planes (CU-UPs), and at least one CU-CP may comprise: configuring a cluster that provides a plurality of radio access points to a specific terminal based on at least one first DU among the plurality of DUs and at least one first CU-UP among the plurality of CU-UPs; and providing cluster configuration information for the configured cluster to at least one of the at least one first DU and the at least one first CU-UP.

### CROSS REFERENCE TO RELATED APPLICATION

The present application claims priority to Korean Patent Application No. 10-2023-0176734, filed on Dec. 7, 2023 and Korean Patent Application No. 10-2024-0131911, filed on Sep. 27, 2024, the entire contents of which are incorporated herein for all purposes by this reference.

### BACKGROUND

### Technical Field

This disclosure relates to data transmission technology using functional split base stations, and more specifically, to data transmission technology for high-capacity transmission networks that enable large-volume transmission by configuring a terminal-centric cluster utilizing multiple radio access points.

This invention was supported by Institute of Information & communications Technology Planning & Evaluation (IITP) grant funded by the Korea government (MSIT) (RS-2018-II180218, Speciality Laboratory for Wireless Backhaul Communications based on Very High Frequency).

### Description of the Related Art

To handle the rapidly increasing wireless data following the commercialization of 4G communication systems (e.g., communication systems supporting LTE), 5G communication systems (e.g., communication systems supporting NR) that use not only the frequency bands of 4G communication systems (e.g., frequency bands below 6 GHz) but also higher frequency bands than those of 4G communication systems (e.g., frequency bands above 6 GHz) may be considered. The 5G communication system can support eMBB (enhanced Mobile Broadband), URLLC (Ultra-Reliable and Low Latency Communication), and mMTC (massive Machine Type Communication).

In such communication systems, ultra-high frequency bands may have large bandwidths and may be easy to allocate continuous wireless resources. Accordingly, if the communication system uses ultra-high frequency bands, a capacity increase effect can be obtained. However, ultra-high frequency bands may have strong directivity and high propagation loss, making it difficult to configure a cellular network. As a result, they may mainly be used in limited areas such as intra-device communication, short-range peer-to-peer (P2P) communication, data centers, and wireless backhaul.

Meanwhile, beamforming technology based on multiple antennas can be applied to mobile communication systems. Accordingly, research may be underway to utilize ultra-high frequency bands, including the terahertz band, in mobile communications. Ultra-high frequency mobile communication radio access can utilize technologies such as ultra-fine beamforming based on large-scale antenna arrays and distributed multi-point multi-antenna technologies to increase system capacity and performance. Additionally, ultra-high frequency mobile communication radio access is expected to shift from traditional cell-centric radio access to flexible beam-based terminal-centric radio access, and data transmission technology suitable for high-capacity transmission networks may be required.

Meanwhile, a base station can be functionally composed of a CU (Central Unit), DU (Distributed Unit), and RU (Remote Unit). Therefore, data transmission technology for high-capacity transmission networks and terminal-centric radio access technology considering such functional split base station systems may be required.

### SUMMARY

Provided are terminal-centric wireless access technology and/or data transmission technology for high-capacity transmission networks, considering a functional split base station system.

An aspect of the present disclosure provides a method of operating a first central unit-control plane (CU-CP) implemented by an electronic device in a functional split base station system that includes a plurality of distributed units (DUs), a plurality of central unit-user planes (CU-UPs), and at least one CU-CP. The method may comprise: configuring a cluster that provides a plurality of radio access points to a specific terminal based on at least one first DU among the plurality of DUs and at least one first CU-UP among the plurality of CU-UPs; and providing cluster configuration information for the configured cluster to at least one of the at least one first DU and the at least one first CU-UP.

In some embodiments, the configuring the cluster may comprise, in response to receiving from one of the plurality of DUs an F1 Application Protocol (F1AP) initial uplink (UL) Radio Resource Control (RRC) message corresponding to an RRC connection setup request message of the specific terminal, configuring the cluster. In some embodiments, the at least one first DU may include the DU that transmitted the F1AP initial UL RRC message.

In some embodiments, the providing the cluster configuration information may comprise providing the cluster configuration information to the DU that transmitted the F1AP initial UL RRC message via an F1AP downlink (DL) RRC transfer message.

In some embodiments, the DU that transmitted the F1AP initial UL RRC message may transmit an RRC connection setup message including the cluster configuration information to the specific terminal.

In some embodiments, the method may further comprise updating the cluster by changing one of the at least one first CU-UP to a second CU-UP.

In some embodiments, the updating the cluster may comprise performing a bearer setup procedure for the second CU-UP.

In some embodiments, the updating the cluster may comprise notifying a CU-CP change to one of the at least one first CU-UP via a bearer release procedure.

In some embodiments, the method may further comprise updating the cluster by changing one of the at least one first DU to a second DU.

In some embodiments, the updating the cluster may comprise updating the cluster in response to receiving, from one of the at least one first DU, an F1AP UL RRC transfer message corresponding to an RRC measurement report of the terminal.

In some embodiments, the updating the cluster may comprise providing the cluster configuration information for the updated cluster to the second DU via an F1AP UE context setup request.

In some embodiments, the updating the cluster may comprise providing the cluster configuration information for the updated cluster to one of the at least one first DU via an F1AP UE mobility command, so that the one of the at least one first DU provides the cluster configuration information to the specific terminal.

In some embodiments, the updating the cluster may comprise releasing the resources allocated to the at least one first DU when the change from one of the at least one first DU to the second DU is completed.

In some embodiments, the configuring the cluster may comprise configuring the cluster in response to receiving an Xn Application Protocol (XnAP) handover request from a second CU-UP that is responsible for the previously configured cluster for the specific terminal.

In some embodiments, the providing the cluster configuration information may comprise providing the cluster configuration information to the second CU-CP via an XnAP handover acknowledgment (ACK), so that the second CU-CP provides the cluster configuration information to the second DU that is the included in the previously configured cluster and managed by the second CU-CP.

In some embodiments, the second DU may provide the provided cluster configuration information to the specific terminal via an RRC connection reconfiguration message.

In some embodiments, the cluster configuration information may include information for identifying the at least one first DU and the at least one first CU-UP.

In some embodiments, a Packet Data Convergence Protocol (PDCP) Protocol Data Unit (PDU) used in the functional split base station system may include a PDCP header, a cluster header, and at least one PDCP Service Data Unit (SDU). In some embodiments, the cluster header may include a cluster identifier. In some embodiments, the cluster identifier may include a CU-CP identifier, a CU-UP identifier, and an identifier for a DU group.

In some embodiments, the PDCP PDU used in the functional split base station system may include a PDCP header, a cluster header, and at least one PDCP SDU. In some embodiments, the cluster header may include the number of the at least one PDCP SDU, a tag indicating whether each of the at least one PDCP SDU is a duplicate transmission, and length information for each of the at least one PDCP SDU.

In some embodiments, the first CU-CP may perform IP data aggregation at the PDCP layer based on the cluster header.

Another aspect of the present disclosure provides an electronic device belonging to a functionally separated base station system that includes a plurality of DUs, a plurality of CU-UPs, and at least one CU-CP. The electronic device may comprise: a processor; at least one hardware-based transceiver; and a computer-readable storage medium including instructions. In some embodiments, the instructions, when executed by the processor, may cause the electronic device to perform the method according to at least one embodiment of the present disclosure.

Yet another aspect of the present disclosure provides a non-transitory recording medium storing instructions readable by a processor of an electronic device. In some embodiments, the instructions may cause the processor to perform at least embodiment of the present disclosure.

This summary is provided to introduce a selection of concepts in a simplified form that are further described in the detailed description below. This summary is not intended to identify key or essential features of the claimed subject matter, nor is it intended to be used to limit the scope of the claimed subject matter. The claimed subject matter is not limited to implementations that solve any or all disadvantages noted in any part of this disclosure. In addition to the exemplary aspects, embodiments, and features described above, further aspects, embodiments, and features will become apparent from the following detailed description and accompanying drawings.

Some embodiments of this disclosure may have an effect including the following advantages. However, since it is not meant that all exemplary embodiments should include all of them, the scope of the present disclosure should not be understood as being limited thereto.

According to some embodiments, in a functionally separated base station system, functions for capacity enhancement and ensuring mobility connectivity can be performed by utilizing a terminal-centric cluster based on features such as Coordinated Multi-Point transmission and reception (CoMP), Carrier Aggregation (CA), Dual Connectivity (DC), Duplication Transmission, and Single Frequency Network (SFN).

According to some embodiments, to efficiently operate a terminal-centric cluster in a functional split base station system, protocol layers for efficient wireless resource allocation, terminal operations, operations of each entity of the functional split base station (e.g., RU, DU, CU-UP, CU-CP), and core network operations can be provided.

According to some embodiments, the terminal-centric cluster for high-capacity transmission can allocate wireless resources to prevent communication disconnection due to changes in the terminal's reception state. This may be achieved by performing high-capacity data transmission using any one of the functions among CoMP, CA, DC, Duplication Transmission, or SFN, depending on the states of the radio access points, thereby improving system performance.

### BRIEF DESCRIPTION OF THE DRAWINGS

FIG. 1 is a conceptual diagram illustrating a communication system and communication nodes according to some embodiments.

FIG. 2 is a block diagram illustrating a communication node.

FIG. 3 is a conceptual diagram illustrating a single base station-based cell and a multi-radio access point set-based cell in a communication system.

FIG. 4 is a conceptual diagram illustrating the configuration of a multi-radio access point set-based cell.

FIG. 5 is a conceptual diagram illustrating a terminal-centric cluster configured based on a functional split base station.

FIG. 6A illustrates the data flow of the L2 layer, and FIG. 6B is a conceptual diagram illustrating the structure of a Protocol Data Unit (PDU) in the L2 layer.

FIG. 7 is a conceptual diagram illustrating a terminal-centric cell.

FIG. 8 is a conceptual diagram illustrating user plane multi-connectivity technology.

FIG. 9 is a conceptual diagram illustrating a functional configuration according to network softwareization.

FIG. 10 is a conceptual diagram illustrating a terminal-centric cluster configured based on a functional split base station.

FIG. 11 is a conceptual diagram illustrating a terminal-centric cluster configured based on radio access points.

FIG. 12 is a conceptual diagram illustrating the configuration of a base station where the CU is split into CP and UP.

FIG. 13 is a conceptual diagram illustrating a radio protocol of a terminal-centric cluster configured based on a functional split base station.

FIG. 14 is a conceptual diagram illustrating a data transmission protocol that provides services to a terminal from multiple functional split base stations.

FIG. 15 is a conceptual diagram illustrating a data transmission protocol that provides services to a terminal through multiple connections from multiple functional split base stations.

FIGS. 16A and 16B are conceptual diagrams illustrating a multi-PDCP-based cluster structure for ensuring the integrity of large-volume data.

FIG. 17 is a conceptual diagram illustrating a multi-PDCP structure.

FIG. 18 is a structural diagram illustrating a multi-PDCP-based PDU.

FIG. 19A and FIG. 19B are flowcharts illustrating a data transmission method for a high-capacity transmission network.

FIG. 20 is a conceptual diagram illustrating a method for operating a terminal-centric cluster.

FIG. 21 is a conceptual diagram illustrating an example method for updating a terminal-centric cluster.

FIG. 22 is a conceptual diagram illustrating a message flow diagram for handling a functional split base station.

FIG. 23 illustrates an message flow diagram for the CU-UP change procedure in a functional split base station.

FIG. 24 is a conceptual diagram illustrating a message flow diagram for the DU change procedure in a functional split base station.

FIG. 25 illustrates a handover procedure message flow in a multi-functional split base station.

### DETAILED DESCRIPTION OF THE DISCLOSURE

Since the description of the present disclosure is merely an exemplary embodiment for structural or functional description, the scope of the present disclosure should not be construed as being limited by the exemplary embodiments described in the text. That is, since exemplary embodiments may be changed in various ways and may have various forms, it should be understood that the right scope of the present disclosure includes equivalents that can realize the technical idea. In addition, the objectives or effects presented in the present disclosure may not mean that a specific exemplary embodiment should include all or only such effects, so the right scope of the present disclosure should not be understood as being limited thereto.

Meanwhile, the meaning of the terms described in the present disclosure should be understood as follows.

Terms such as “first”, “second”, and the like are intended to distinguish one component from another component, and the scope of rights should not be limited by these terms. For example, a first component may be referred to as a second component, and similarly, a second component may also be referred to as a first component.

When a component is referred to as being “connected” to another component, it may be directly connected to the other component, but it should be understood that other components may exist in the middle. On the other hand, when a component is referred to as being “directly connected” to another component, it should be understood that no other component exists in the middle. Meanwhile, other expressions describing the relationship between components, such as “between” and “immediately between” or “neighboring to” and “directly neighboring to”, should be interpreted in the same way.

Singular expressions should be understood to include plural expressions unless the context clearly indicates otherwise, and terms such as “include” or “have” are intended to designate the existence of features, numbers, steps, actions, components, parts, or combinations thereof, and should be understood not to preclude the possibilities of the existence or addition of one or more other features or numbers, steps, actions, components, parts, or combinations thereof.

In each step, identification codes (e.g., a, b, c, etc.) may be used for the convenience of explanation, and identification codes may not describe the order of each step, and each step may occur differently from the specified order unless a specific order is explicitly stated in the context. That is, each step may occur in the same order as the specified order, may be performed substantially simultaneously, or may be performed in the opposite order.

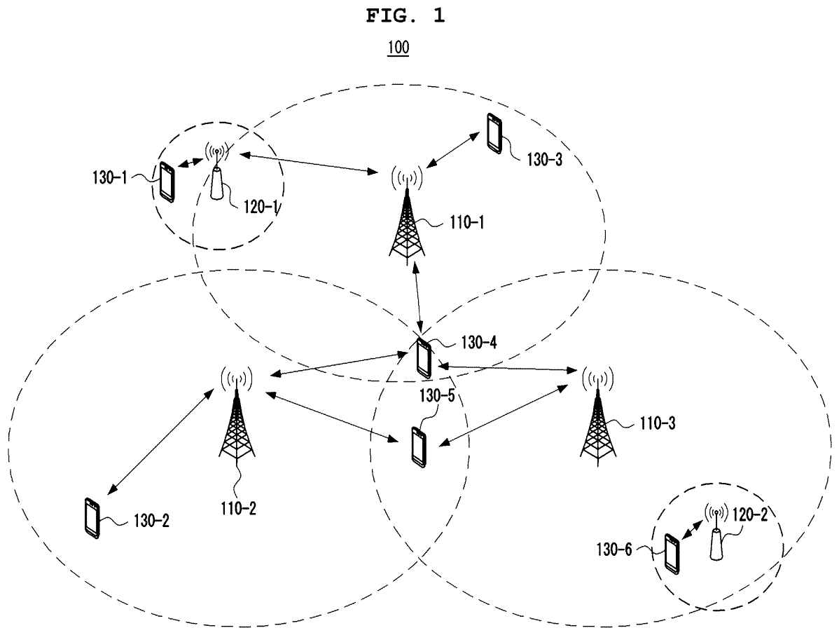

FIG. 1 is a conceptual diagram illustrating a communication system and communication nodes according to some embodiments.

Referring to FIG. 1, the communication system 100 may include a plurality of communication nodes 110-1, 110-2, 110-3, 120-1, 120-2, 130-1, 130-2, 130-3, 130-4, 130-5, and 130-6. Here, the communication system may be referred to as a “communication network.” Each of the plurality of communication nodes may support at least one communication protocol. For example, each of the plurality of communication nodes may support a communication protocol based on CDMA (Code Division Multiple Access), a communication protocol based on WCDMA (Wideband CDMA), a communication protocol based on TDMA (Time Division Multiple Access), a communication protocol based on FDMA (Frequency Division Multiple Access), a communication protocol based on OFDM (Orthogonal Frequency Division Multiplexing), a communication protocol based on OFDMA (Orthogonal Frequency Division Multiple Access), a communication protocol based on SC-FDMA (Single Carrier-FDMA), a communication protocol based on NOMA (Non-Orthogonal Multiple Access), a communication protocol based on SDMA (Space Division Multiple Access), and the like. Each of the plurality of communication nodes may have the following structure.

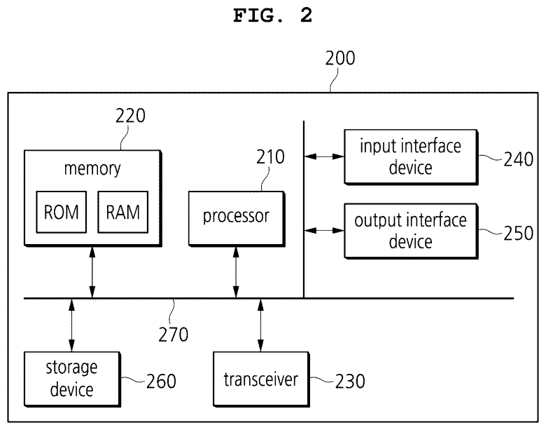

FIG. 2 is a block diagram illustrating a communication node.

Referring to FIG. 2, the communication node 200 may include at least one processor 210, memory 220, and a transceiver 230 connected to a network to perform communication. Additionally, the communication node 200 may further include an input interface device 240, an output interface device 250, and a storage device 260. Each component included in the communication node 200 can be connected via a bus 270 to communicate with each other. However, each component included in the communication node 200 may be connected through individual interfaces or individual buses centered around the processor 210, rather than a common bus 270. For example, the processor 210 may be connected to at least one of the memory 220, the transceiver 230, the input interface device 240, the output interface device 250, and the storage device 260 via dedicated interfaces.

The processor 210 may execute program commands stored in at least one of the memory 220 and the storage device 260. The processor 210 may refer to a central processing unit (CPU), a graphics processing unit (GPU), or a dedicated processor which performs methods according to embodiments of the present disclosure. Each of the memory 220 and the storage device 260 may be configured with at least one of a volatile storage medium and a non-volatile storage medium. For example, the memory 220 may be configured with at least one of a read-only memory (ROM) and a random-access memory (RAM).

Referring back to FIG. 1, the communication system 100 may include multiple base stations (BS) 110-1, 110-2, 110-3, 120-1, 120-2, and multiple terminals 130-1, 130-2, 130-3, 130-4, 130-5, 130-6. Each of the first base station 110-1, the second base station 110-2, and the third base station 110-3 may form a macro cell. Each of the fourth base station 120-1 and the fifth base station 120-2 may form a small cell. Within the coverage of the first base station 110-1, the fourth base station 120-1, the third terminal 130-3, and the fourth terminal 130-4 may be included. Within the coverage of the second base station 110-2, the second terminal 130-2, the fourth terminal 130-4, and the fifth terminal 130-5 may be included. Within the coverage of the third base station 110-3, the fifth base station 120-2, the fourth terminal 130-4, the fifth terminal 130-5, and the sixth terminal 130-6 may be included. The first terminal 130-1 may be included within the coverage of the fourth base station 120-1. The sixth terminal 130-6 may be included within the coverage of the fifth base station 120-2.

Here, each of the plurality of base stations 110-1, 110-2, 110-3, 120-1, 120-2 may be referred to as a gNodeB (next generation Node B, gNB), NodeB, evolved NodeB (eNB), base transceiver station (BTS), radio base station, radio transceiver, access point, access node, roadside unit (RSU), DU (digital unit), CDU (cloud digital unit), RRH (radio remote head), RU (radio unit), TP (transmission point), TRP (transmission and reception point), relay node, and the like. Each of the plurality of terminals 130-1, 130-2, 130-3, 130-4, 130-5, 130-6 may be referred to as an access terminal, mobile terminal, station, subscriber station, mobile station, portable subscriber station, user equipment (UE), node, device, and the like.

Each of the plurality of communication nodes 110-1, 110-2, 110-3, 120-1, 120-2, 130-1, 130-2, 130-3, 130-4, 130-5, 130-6 may support cellular communication (e.g., Long Term Evolution (LTE), LTE-Advanced (LTE-A), etc., as defined in 3GPP (3rd Generation Partnership Project) standards). Each of the plurality of base stations 110-1, 110-2, 110-3, 120-1, 120-2 may operate in different frequency bands or may operate in the same frequency band. Each of the plurality of base stations may be connected to each other via an ideal backhaul or a non-ideal backhaul and may exchange information with each other through the backhaul. Each base station may be connected to a core network (not shown) via an ideal or non-ideal backhaul. Each base station may transmit signals received from the core network to its corresponding terminals 130-1 to 130-6 and may transmit signals received from the terminals to the core network.

Each of the plurality of base stations may support downlink (DL) transmission based on OFDMA and uplink (UL) transmission based on SC-FDMA. Additionally, each base station can support MIMO (Multiple Input Multiple Output) transmission (e.g., Single User (SU)-MIMO, Multi-User (MU)-MIMO, Massive MIMO), Coordinated Multipoint (CoMP) transmission, Carrier Aggregation (CA) transmission, transmission in unlicensed bands, and device-to-device (D2D) communication (or Proximity Services (ProSe)). Here, each of the plurality of terminals 130-1 to 130-6 may perform operations corresponding to the base stations 110-1, 110-2, 110-3, 120-1, 120-2 and operations supported by the base stations.

For example, the second base station 110-2 may transmit signals to the fourth terminal 130-4 based on the SU-MIMO scheme, and the fourth terminal 130-4 may receive signals from the second base station 110-2 via the SU-MIMO scheme. Alternatively, the second base station 110-2 may transmit signals to the fourth terminal 130-4 and the fifth terminal 130-5 based on the MU-MIMO scheme, and each of the fourth terminal 130-4 and the fifth terminal 130-5 may receive signals from the second base station 110-2 via the MU-MIMO scheme. Each of the first base station 110-1, the second base station 110-2, and the third base station 110-3 may transmit signals to the fourth terminal 130-4 based on the CoMP scheme, and the fourth terminal 130-4 may receive signals from the first base station 110-1, the second base station 110-2, and the third base station 110-3 via the CoMP scheme. Each of the plurality of base stations may transmit and receive signals with terminals within their coverage based on the CA scheme. Each of the first base station 110-1, the second base station 110-2, and the third base station 110-3 may coordinate D2D communication between the fourth terminal 130-4 and the fifth terminal 130-5, and each of the fourth terminal 130-4 and the fifth terminal 130-5 may perform D2D communication under the coordination of the second base station 110-2 and the third base station 110-3.

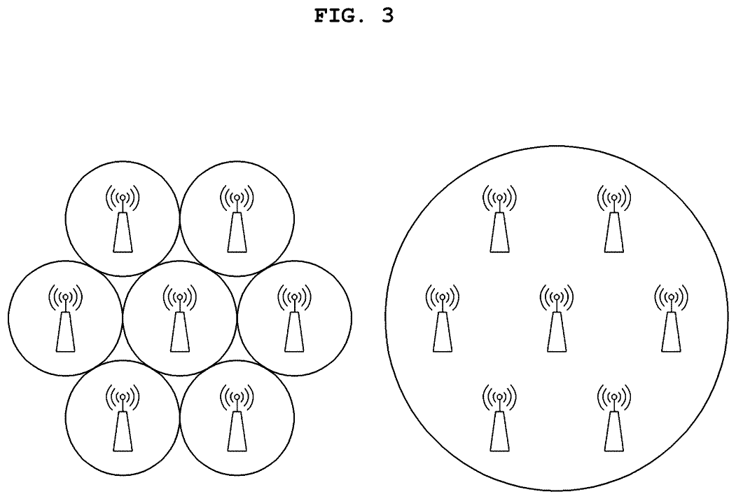

FIG. 3 is a conceptual diagram illustrating a single base station-based cell and a multi-radio access point set-based cell in a communication system.

Traditional mobile communication networks may provide a cellular network based on cells generated by a single base station, as illustrated in the left diagram of FIG. 3. In contrast, cells composed of ultra-high frequency regions, due to their frequency characteristics, may be configured as logical entities consisting of one or multiple radio access points to form a cellular network, as illustrated in the right diagram of FIG. 3.

In communication systems beyond 5G, a large number of transmission points may be densely deployed to increase system capacity in environments with densely populated terminals. In an ultra-dense network (UDN) (e.g., densely populated urban networks), ultra-high frequency cells may be composed of many radio access points and may provide various types of transmission areas.

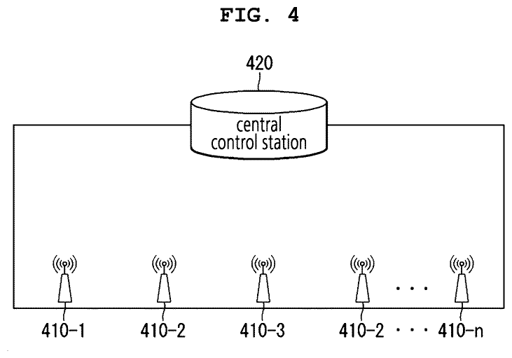

FIG. 4 is a conceptual diagram illustrating the configuration of a multi-radio access point set-based cell.

Referring to FIG. 4, the communication system may include multiple radio access points (410-1 to 410-n) and a central control station (420). The central control station (i.e., network side) (420) may determine a new optimal set of radio access points that follow the terminal according to the movement of the terminal. This flexibly optimized serving radio access point set may provide a terminal-centric cell (i.e., a logical communication area) to the terminal. Therefore, the terminal-centric cell may not have a strict association with the radio access points in the network, in order to provide the terminal with an experience as if it is located at the center of the terminal-centric cell. Such a terminal-centric cell can provide synchronization signals and broadcast information, as well as support initial access and inter-cell mobility of the terminal in ultra-high frequency cells. Each radio access point (410-1 to 410-n) may configure a terminal-centric cell area through the central control station (420) and may operate beam resources.

Meanwhile, the radio access protocol may provide functions for exchanging data and control information by utilizing radio resources among multiple communication nodes over the radio interface. Such a radio access protocol may be hierarchically structured. In LTE (Long Term Evolution), LTE-Advanced (LTE-A), NR (New Radio), etc., proposed by the 3rd Generation Partnership Project (3GPP), the radio access protocol may be composed of Layer 1 (L1) that constructs physical signals, Layer 2 (L2) that controls radio transmission in shared radio resources used by multiple communication nodes and transmits and aligns data to the counterpart node, and Layer 3 (L3) that controls radio resource management such as network information sharing, radio connection management, mobility management, and QoS (Quality of Service) management among multiple communication nodes participating in the wireless network.

Here, L1 may be the Physical (PHY) layer and can provide functions for data transmission. L2 may be composed of sublayers such as Medium Access Control (MAC), Radio Link Control (RLC), Packet Data Convergence Protocol (PDCP), and Service Data Adaptation Protocol (SDAP). Layer 3 may be the Radio Resource Control (RRC) layer and may provide control functions for the Access Stratum (AS) layer.

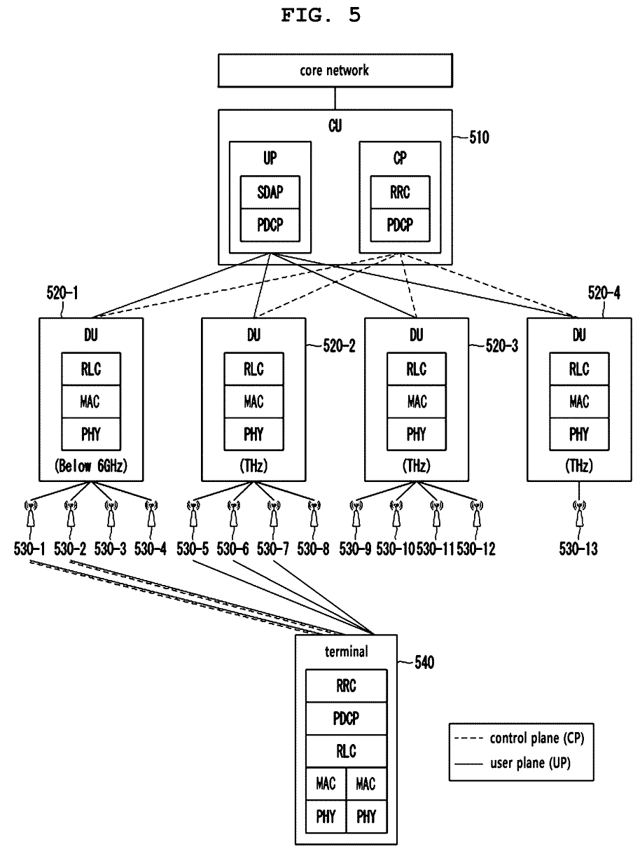

FIG. 5 is a conceptual diagram illustrating a terminal-centric cluster configured based on a functional split base station.

Referring to FIG. 5, the base station may be composed of a CU (Central Unit) 510, DUs (Distributed Units) 520-1 to 520-4, and radio access points 530-1 to 530-13.

Here, the CU 510 of the base station may be a logical node that performs RRC, SDAP, and PDCP layer functions of the radio access protocol and may control the operation of at least one of the DUs 520-1 to 520-4.

The base station CU 510 may be connected to an end node of the core network using an Si interface (in a 3GPP LTE/LTE-A system) or an NG interface (in a 3GPP NR system's gNB) based on backhaul.

The CU 510 of the base station may have a user plane (UP) that performs SDAP and PDCP functions and a control plane (CP) that performs RRC and PDCP functions.

Next, the DUs 520-1 to 520-4 of the base station may be logical nodes that perform the functions of the base station's RLC, MAC, and PHY layers and can support one or more cells.

Also, the CU 510 and the DUs 520-1 to 520-4 of the base station may be connected via a wired or wireless method using the F1 interface of a 3GPP system.

The DUs 520-1 to 520-4 of the base station may be connected to the radio access points 530-1 to 530-13 via a wired or wireless Fx interface (or fronthaul).

In some embodiments, the radio access points 530-1 to 530-13 may be configured in the form of Transmission Points (Tx/Rx Point, TRP), Remote Radio Heads (RRH), relays, or repeaters in a 3GPP system.

In some embodiments, the radio access points 530-1 to 530-13 may perform RU (Remote Unit) functions.

In some embodiments, a TRP may perform at least one of the downlink transmission function from the base station to the terminal and the uplink reception function in the opposite direction. For example, the TRP may perform both downlink transmission and uplink reception functions. In another example, the TRP may perform only the downlink transmission function. In yet another example, the TRP may perform only the uplink reception function.

In some embodiments, the radio access points 530-1 to 530-13 may perform only RF functions. In other embodiments, the radio access points 530-1 to 530-13 may include some functions of the base station DU-such as the physical layer and/or MAC layer-in addition to RF functions. For example, if the radio access points 530-1 to 530-13 include some functions of the DUs 520-1 to 520-4, they can include lower functions of the physical layer, physical layer functions, and/or lower functions of the MAC layer.

Therefore, the Fx interface between the DUs 520-1 to 520-4 and the radio access points 530-1 to 530-13 may be defined differently depending on which functions of the physical layer and/or MAC layer are performed by the radio access points 530-1 to 530-13.

Meanwhile, some radio access points-530-1, 530-2, 530-5, 530-6, and 530-7—may form a terminal-centric cell to provide services to a terminal 540.

At this time, some of the radio access points 530-1, 530-2, 530-5, 530-6, and 530-7 may form the user plane, and some radio access points 530-1 and 530-2 may form the control plane.

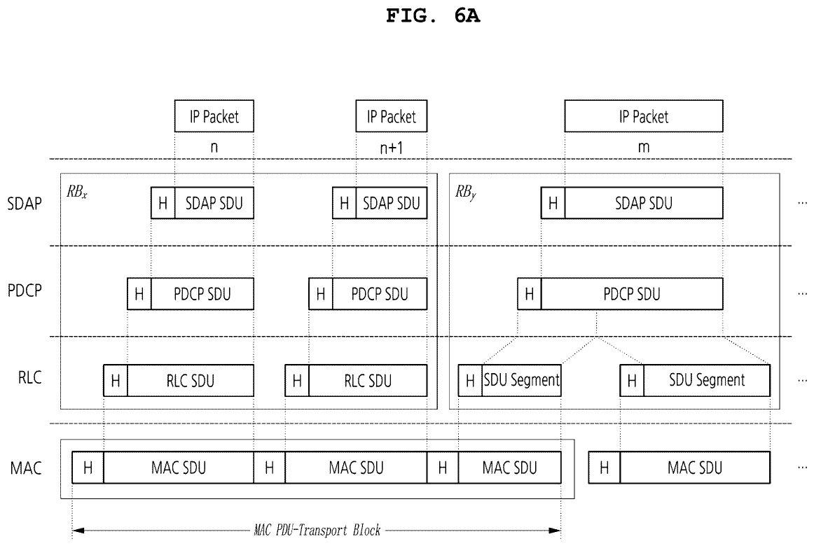

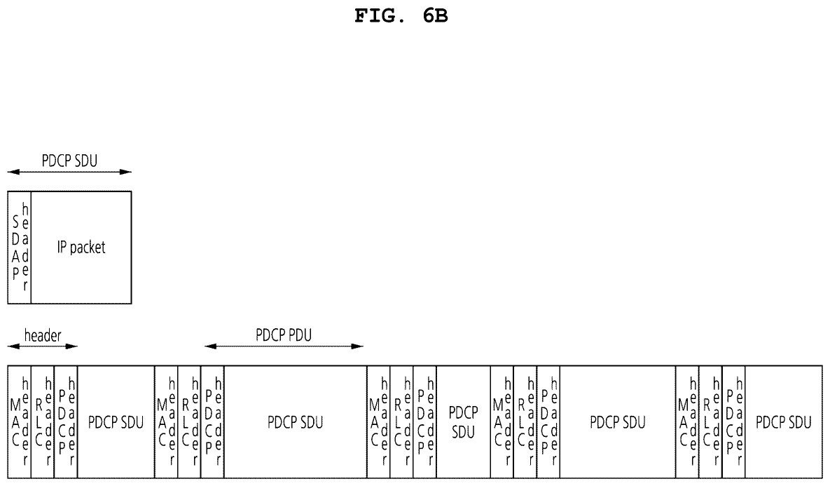

FIG. 6A illustrates the data flow of the L2 layer, and FIG. 6B is a conceptual diagram illustrating the structure of a Protocol Data Unit (PDU) in the L2 layer.

As shown in FIG. 6a, each layer of L2 may attach a header to the incoming upper-layer Service Data Unit (SDU) to generate a PDU, and construct a Transport Block at the MAC layer, which is then passed to the L1 layer.

For example, as illustrated in FIG. 6b, the SDAP layer may attach an SDAP header to an IP packet to form a PDCP SDU. Then, the PDCP layer may attach a PDCP header to the PDCP SDU to generate a PDCP PDU.

In this process, since each layer generates a PDU by attaching headers to the IP packet on a per-packet basis, excessive overhead due to the additional headers may occur during large-volume transmissions.

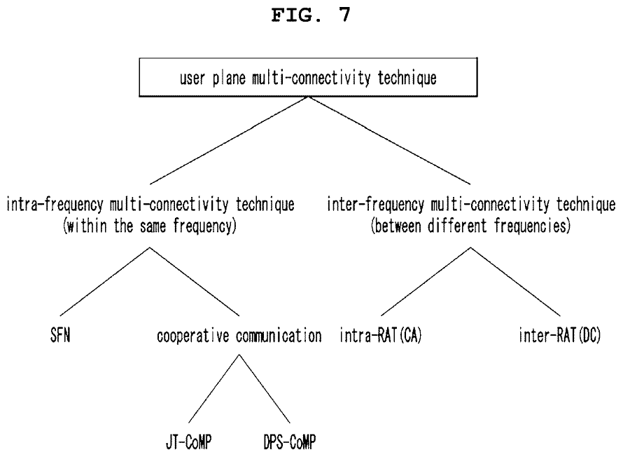

FIG. 7 is a conceptual diagram illustrating a terminal-centric cell.

Referring to FIG. 7, radio access points 710-1 to 710-3 may form a terminal-centric cell to provide service to the first terminal 720-1.

Furthermore, radio access points 710-3 to 710-5 may form a terminal-centric cell to provide service to the second terminal 720-2.

Additionally, radio access points 710-8 to 710-10 may form a terminal-centric cell to provide service to the fourth terminal 720-4.

Moreover, radio access points 710-10 to 710-12 may form a terminal-centric cell to provide service to the fifth terminal 720-5.

Thus, a single terminal-centric cell may include multiple radio access points that may be interconnected via a combination of ideal or non-ideal backhaul links.

Fine-beam-based cell configuration scenarios are not limited to the Cloud Radio Access Network (CRAN) architecture and ideal backhaul (implying near-zero latency for infinite backhaul data rates) but may be extended to radio access points that cooperate under central control.

In a single terminal-centric cell, radio access points connected via non-ideal backhaul may include various radio access protocol entities.

Meanwhile, ultra-high frequency bands have advantages such as supporting wide continuous bandwidth, increased propagation directivity, and miniaturized antennas.

On the other hand, ultra-high frequency bands may have disadvantages like significant signal attenuation and loss, resulting in shorter propagation distances and severe interference or blockage due to obstacles.

Therefore, to overcome these disadvantages and provide service area, mobility, reliability, and availability, support for multi-connectivity between base stations or between different Radio Access Technologies (RATs) may be required.

Multi-connectivity may refer to a terminal establishing and maintaining multiple connections with various types of base stations or access points.

Types of multi-connectivity may be classified into intra-frequency multi-connectivity or inter-frequency multi-connectivity based on the frequencies applied in the system.

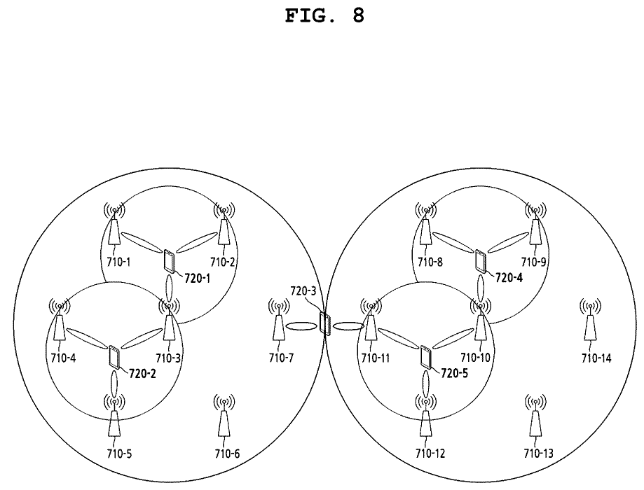

FIG. 8 is a conceptual diagram illustrating user plane multi-connectivity technology.

Referring to FIG. 8, user plane multi-connectivity technology may include intra-frequency multi-connectivity (e.g., multi-connectivity within the same frequency range) and inter-frequency multi-connectivity (e.g., multi-connectivity between different frequency ranges).

Examples of intra-frequency multi-connectivity technologies include SFN (Single Frequency Network) and coordinated communication. Intra-frequency multi-connectivity may require a common MAC layer to adjust the MCS (Modulation and Coding Scheme), transmission resources, methods, etc., in the scheduler. Additionally, in intra-frequency multi-connectivity, the transmission delay to the access points may be very small to achieve synchronization between them. Such intra-frequency multi-connectivity technologies may include SFN, JT-CoMP (Joint Transmission Coordinated Multi-Point), and DPS-CoMP (Dynamic Point Selection CoMP). In SFN, signals transmitted at the same frequency from multiple base stations may be synchronized so that they are received within the cyclic prefix of an OFDM symbol at the terminal.

When broadcast/multicast transmission is performed in intra-frequency multi-connectivity, each base station may transmit the same data using the same MCS and radio resources without channel information of the terminal. Additionally, when data transmission to a specific terminal is performed, each base station may receive beam information from the terminal and transmit the same data using the same MCS and radio resources through the selected base station and beam based on the received information.

By combining signals received from multiple base stations, the terminal may overcome propagation blockage/interference caused by obstacles.

In JT-CoMP, the terminal may measure beam reference signals received from each base station and transmit the base station ID, beam ID, and channel state information to the base stations. Based on this information, JT-CoMP may calculate weights between base stations and transmit data through base stations with different weights applied, using the same MCS and radio resources.

JT-CoMP may overcome service interruptions due to propagation blockage because it can receive signals from other beams even if one beam's signal is blocked by obstacles, thereby improving the received signal quality.

DPS-CoMP may transmit data by selecting the optimal base station and beam for the terminal based on the channel information of each base station and beam transmitted by the terminal. Such DPS-CoMP may support service continuity or mobility by quickly performing beam switching to another base station's beam if propagation blockage of the serving beam occurs due to obstacles.

Since the communication system can support wide frequency bandwidths in the ultra-high frequency region, it may divide the frequency band into multiple carrier frequencies and configure multiple RATs (Radio Access Technologies) by applying different numerologies according to service requirements. Additionally, the communication system may configure a network using both sub-6 GHz band RATs and ultra-high frequency band RATs.

Inter-frequency multi-connectivity technologies may include carrier aggregation (CA) in intra-RAT environments and dual connectivity (DC) in inter-RAT environments. CA may transmit and receive data using two or more carrier frequencies. In the ultra-high frequency band, available continuous frequency bandwidths may be utilized. CA may configure RATs suitable for large-volume traffic transmission and various service types by dividing a wide frequency bandwidth into multiple carrier frequencies. DC was proposed to improve the performance of small cells and may have the feature of transmitting data simultaneously from a macrocell eNB and a small cell eNB connected via a non-ideal backhaul through the X2 interface.

The fusion of connections between two cells may be possible at the S-GW (Serving Gateway) or PDCP layer. Multiple RAT connections may be integrated at the PDCP layer. The user plane controller of the PDCP layer may perform storage, distribution, and coordination of data between base stations. Additionally, the user plane controller of the PDCP layer may guarantee the sequential transmission of received data packets. When transmitting data simultaneously through different RATs, the user plane controller of the PDCP layer may control the traffic transmission amount considering the transmission bandwidth and delay between RATs to prevent delays during sequential data transmission processing at the PDCP layer.

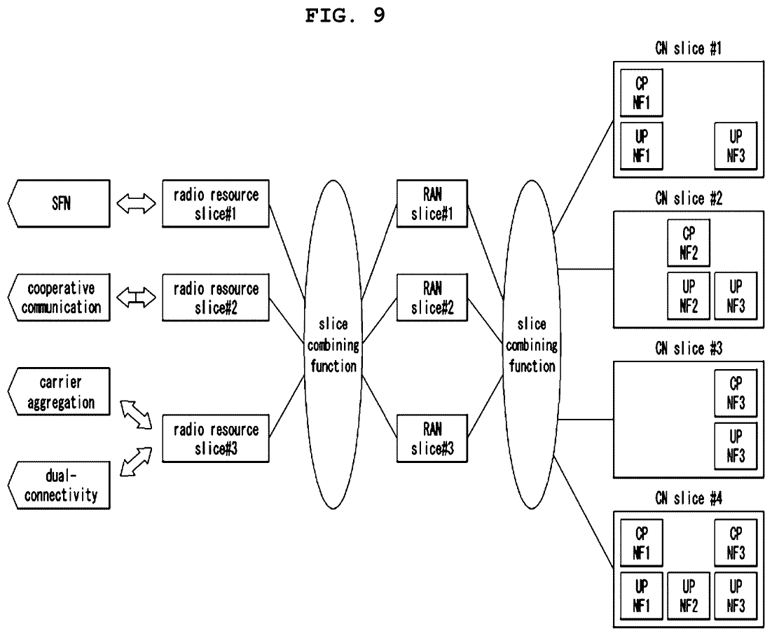

FIG. 9 is a conceptual diagram illustrating a functional configuration according to network softwareization.

Referring to FIG. 9, network softwareization is a crucial factor in network evolution, allowing the separation of common physical network infrastructure into hardware and software. Additionally, network softwareization enables various logical or virtual network configurations according to service scenarios and business models through technologies like Software Defined Networking (SDN) and Network Function Virtualization (NFV).

These logical or virtual networks may be defined as network slices. Network slices may satisfy various service-based requirements primarily according to business needs. They have been proposed mainly for the 5G core network, where a virtualized core network may be dynamically configured for business purposes using SDN and NFV. The 5G RAN may be designed to allocate functions and resources suitable for the characteristics of each slice, enabling the configuration of network slices for various purposes.

Considering the impact and support of network slices, the requirements necessary for RAN design may involve configuring multiple network slices based on service or business scenarios to maximize resource utilization. Each network slice may be configured as multiple logical networks within the same physical network infrastructure rather than as separate physical networks.

The RAN may support the efficient use of radio resources, transmission links, and infrastructure resources among multiple network slices. For example, in the case of a network slice where data transmission rate changes are minimal and low latency and ultra-reliability are required, it may be efficient to allocate statically independent radio resources.

Conversely, if the PAN allocates dedicated resources to network slices with rapidly changing traffic patterns, resource utilization may be low, or data loss may occur. For these network slices, resource utilization may be improved if the PAN allocates shared resources and assigns them according to a scheduling mechanism. Therefore, in RAN design, it may be necessary to consider a resource allocation algorithm suitable for the traffic requirements of each slice.

From the aspect of network slice identification, the current 3GPP core network may support Quality of Service (QoS) mechanisms. It may be necessary to examine whether these mechanisms can be applied to all network slices in the PAN without network slice identification. For example, the RAN may require priority information for each network slice when scheduling shared radio resources. To support this, network slice identifier information may be needed in the RAN.

A mechanism may be required to apply priorities to traffic types within network slices. The RAN scheduler may verify whether additional functions are needed to distinguish the priority of traffic flows between and within slices for resource allocation.

When multiple network slices share radio resources, minimizing the impact between slices may be necessary. If traffic congestion occurs in one network slice, it may be necessary to design a protection mechanism between slices to prevent it from affecting other network slices.

From the perspective of infrastructure management support, interface design for an infrastructure management mechanism may be needed to support the creation, modification, and deletion of slices suitable for network slice requirements such as mobility, traffic patterns, delay, and jitter.

Meanwhile, ultra-high frequency-based mobile communication systems may use beam-based antenna patterns. These beam-based antenna patterns may cause dynamic changes in service area, signal quality, and channel quality if the beam directionality changes due to small movements or rotations of the terminal. Additionally, signal blockage due to obstacles may easily occur, significantly reducing the beam service area and causing frequent handovers to beams of other base stations. To overcome this, the ultra-high frequency-based mobile communication system may use base station clustering that supports terminal mobility without affecting the core network.

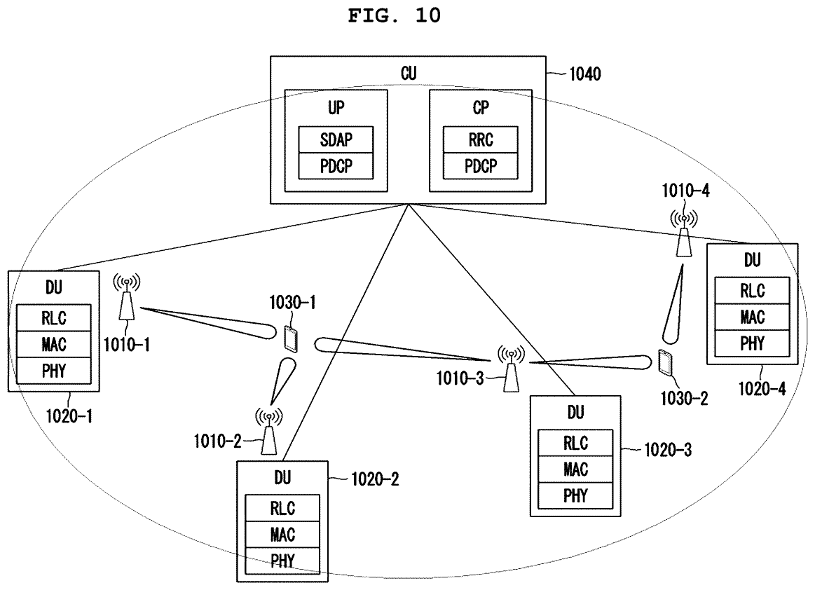

FIG. 10 is a conceptual diagram illustrating a terminal-centric cluster configured based on a functional split base station.

Referring to FIG. 10, the first radio access point 1010-1 associated with the first DU (Distributed Unit) 1020-1, the second radio access point 1010-2 associated with the second DU 1020-2, and the third radio access point 1010-3 associated with the third DU 1020-3 may form a base station cluster to provide services to the first terminal 1030-1.

Additionally, the third radio access point 1010-3 associated with the third DU 1020-3 and the fourth wireless access point 1010-4 associated with the fourth DU 1020-4 may also form a base station cluster to provide services to the second terminal 1030-2.

In such a terminal-centric cluster, handovers between nodes or beams due to the movement of the terminal or propagation blockage by obstacles may be performed within the terminal-centric cluster without core network signaling. Thus, a terminal-centric cluster may be a group of base stations that can provide services to a terminal. Such a terminal-centric cluster may be configured based on the location of each terminal.

Radio access points may be added to or removed from the terminal-centric cluster according to the movement of the terminal. Any radio access point may be designated as a reference radio access point within the terminal-centric cluster to coordinate beam switching within the radio access point or beam handovers between radio access points due to the terminal's movement. The reference radio access point may establish connections with the core network and all radio access points within the cluster.

The configuration method of the terminal-centric cluster may be classified into functional split-based clustering according to the quality and capacity of the transmission links to the radio access points. When using transmission links with limited bandwidth, the terminal-centric cluster may be configured based on higher-layer functional split-based clustering. In this case, the CU (Central Unit) may process protocol stacks that are less sensitive to delay. The DU may process up to the L2 layer, which is sensitive to delay, and perform resource allocation and beamforming functions. The higher-layer function split-based clustering configuration method may be divided into distributed mode and centralized mode.

In the distributed mode, the reference radio access point may be selected from among the radio access points forming the cluster. When beam switching occurs to other radio access points excluding those handled by the reference radio access point, the reference radio access point may perform data forwarding to these radio access points. Data forwarding can be performed at the RLC layer or MAC layer.

In the centralized mode, the reference radio access point can be selected among the DUs. The radio access points forming the terminal-centric cluster may receive data from the CU. The CU may transmit data processed at the PDCP layer to the radio access point where the terminal's serving beam is located.

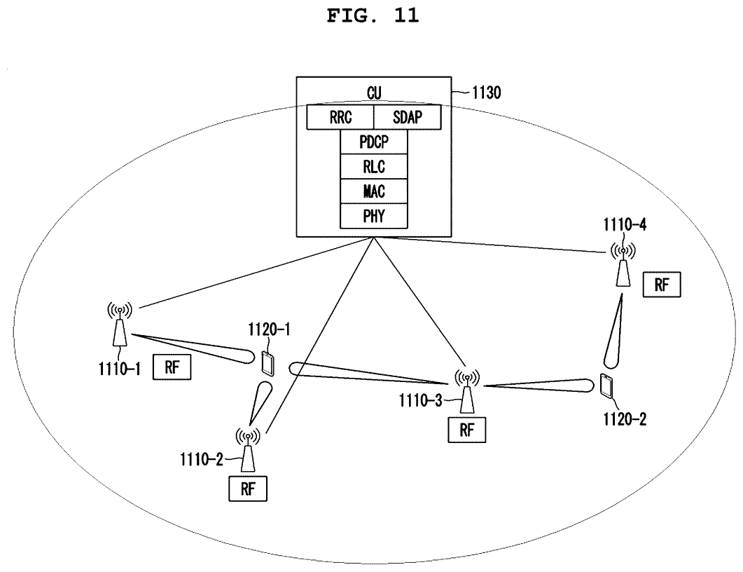

FIG. 11 is a conceptual diagram illustrating a terminal-centric cluster configured based on radio access points.

Referring to FIG. 11, the first radio access point (1110-1), the second radio access point (1110-2), and the third radio access point (1110-3) may form a terminal-centric cluster to provide services to a first terminal (1120-1). Additionally, the third radio access point (1110-3) and the fourth radio access point (1110-4) may also form a terminal-centric cluster to provide services to a second terminal (1120-2).

Such a radio access point-based terminal-centric cluster may divide the base station into a CU (Central Unit) (1130) and RUs (Remote Units). The CU (1130) may process all protocol functions of the control plane and the user plane. The radio access points (1110-1 to 1110-4) may perform RU functions and handle the RF parts like Remote Radio Heads (RRH). The terminals (1120-1 and 1120-2) may measure beam reference signals and transmit a list of optimal radio access points and beam information to the CU (1130). Then, the CU (1130) may determine the radio access points (1110-1 to 1110-4) and beams that will provide services to the terminals (1120-1 and 1120-2).

The radio access points (1110-1 to 1110-4) may perform analog beamforming, and beam weighting information may be received from the CU (1130). If signal attenuation or propagation blockage due to obstacles occurs for the terminals (1120-1 and 1120-2), the CU (1130) may perform rapid beam switching to other serviceable radio access points (1110-1 to 1110-4). To facilitate this, the reference radio access point may track and manage the available radio access points (1110-1 to 1110-4) and beam information for the terminals (1120-1 and 1120-2).

As the terminals (1120-1 and 1120-2) move, addition or deletion of the radio access points (1110-1 to 1110-4) that constitute the cluster may be performed. The terminals (1120-1 and 1120-2) may receive common reference signals and beam reference signals to measure the signal quality of each beam and may perform measurement reporting periodically or based on events. The reference radio access point may change the reference radio access point or add or delete radio access points (1110-1 to 1110-4) based on the measurement reports.

Mobility support within the cluster may be performed based on beam switching. Based on the measurement reports transmitted from the terminals (1120-1 and 1120-2), the reference radio access point may determine intra-beam switching and inter-beam switching. Intra-beam switching may be performed within the cluster configured by the CU (1130). The scheduler may quickly perform beam switching to adjacent beams if measured signal quality information indicates degradation or if propagation interference of the serving beam occurs due to obstacles. If the radio access points (1110-1 to 1110-4) that received measurement reports from the terminals (1120-1 and 1120-2) require inter-beam switching, they may send the measurement report information to the reference radio access point. The reference radio access point may request beam switching to the target radio access point, and upon receiving a response, may notify the serving radio access point of the beam switching. Accordingly, the terminals (1120-1 and 1120-2) may switch to the target beam and receive data from the target radio access point.

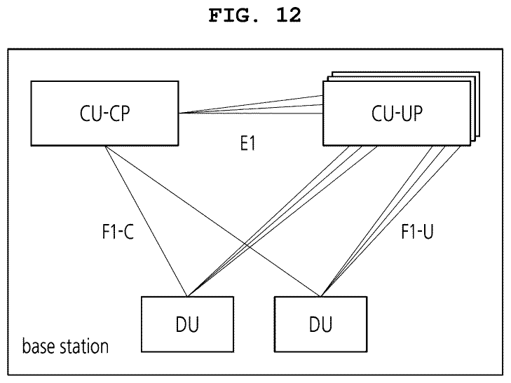

FIG. 12 is a conceptual diagram illustrating the configuration of a base station where the CU is split into CP and UP.

To optimize the placement of PAN functions according to various scenarios and performance requirements, as illustrated in FIG. 12, the base station CU may be further split into a CU-CP (Central Unit-Control Plane) and CU-UP (Central Unit-User Plane). In other words, a base station can be configured with a 1:N structure of CU-CP and multiple CU-UPs, in addition to the existing CU-DU split structure. An interface called E1, which is a newly defined control plane interface, may be established between the CU-CP and CU-UPs. Meanwhile, each DU may be connected to the CU-CP via an F1-C interface and may be connected to the CU-UP via an F1-U interface.

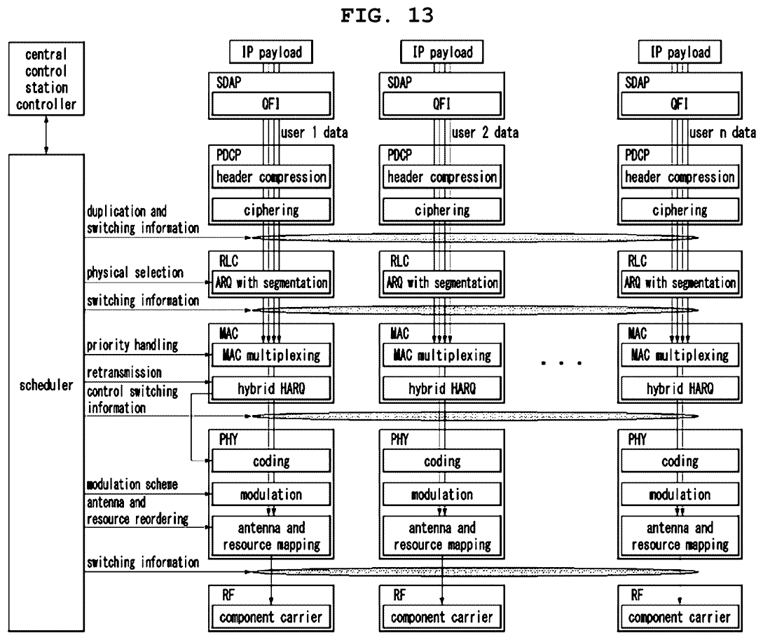

FIG. 13 is a conceptual diagram illustrating a radio protocol of a terminal-centric cluster configured based on a functional split base station.

Referring to FIG. 13, a controller of a central control station may configure a flexible radio protocol through switch functions within the functional split base station structure. A protocol entity of each layer may flexibly select radio access points to form a terminal-centric cluster according to a multi-connectivity function performed in a state where functional split is applied.

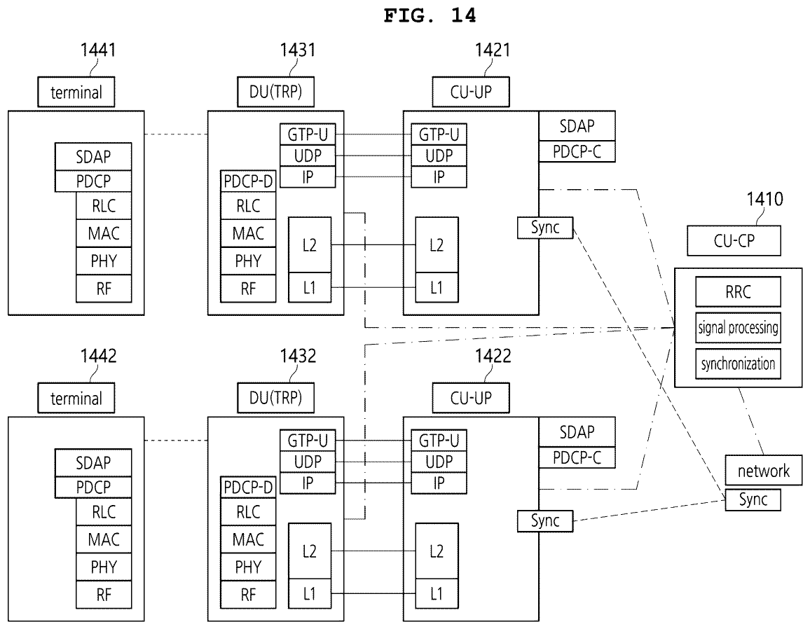

FIG. 14 is a conceptual diagram illustrating a data transmission protocol that provides services to a terminal from multiple functional split base stations.

In some embodiments, as illustrated in FIG. 14, the CU-CP (1410) may perform signal processing and synchronization functions for generation of data paths and control of protocols of functional split-applied base stations. In other embodiments, the entity performing these functions may be a device that exists separately from the CU-CP (1410), unlike what is illustrated in FIG. 14.

In some embodiments, the CU-CP (1410) may generate paths for cluster management and data path transmission of a set including CU-CPs (1421, 1422) and DUs (1431, 1432), and manage the mapping and switching of each protocol entity. According to certain embodiments, the set may also include RUs (not shown).

In some embodiments, the CU-CP (1410) may supervise signal processing for each terminal (1441, 1442) through connected paths and perform synchronization functions for data transmission using the applied multi-connectivity technology.

Data may be redundantly transmitted to ensure data integrity and flexible data transmission through multiple paths. To this end, the PDCP may perform data integrity functions as being split into PDCP-C (PDCP-central) and PDCP-D (PDCP-distribute).

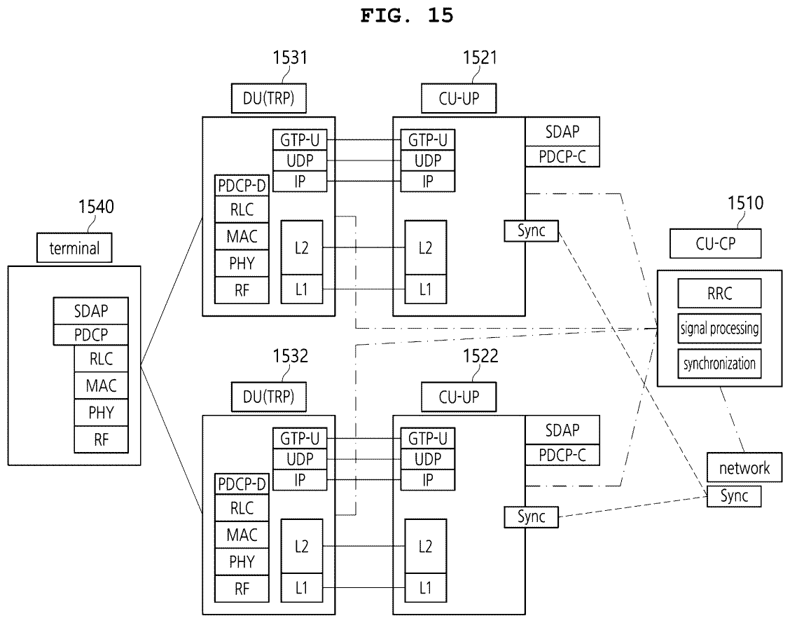

FIG. 15 is a conceptual diagram illustrating a data transmission protocol that provides services to a terminal through multiple connections from multiple functional split base stations.

A terminal-centric cluster based on a group of multiple radio access points may consist of a set of radio access points based on a single CU (Central Unit) or a set based on multiple CUs. In some embodiments, as illustrated in FIG. 15, a single terminal (1540) may connect to multiple DUs (1531, 1532) to receive services corresponding to duplicate transmission or split transmission.

In some embodiments, as illustrated in FIG. 15, the CU-CP (1510) may perform signal processing and synchronization functions for data path creation and protocol control in functionally separated base stations. In other embodiments, the entity performing these functions may be a device that exists separately from the CU-CP (1510), unlike what is illustrated in FIG. 15.

In some embodiments, the CU-CP (1510) may generate paths for cluster management and data path transmission for a set including CU-CPs (1521, 1522) and DUs (1531, 1532), and manage the mapping and switching of each protocol entity. According to certain embodiments, this set may also include RUs (not shown).

In some embodiments, the CU-CP (1510) may supervise signal processing for the terminal (1540) through the connected paths and perform synchronization functions for data transmission using the applied multi-connectivity technology.

Data may be redundantly transmitted to ensure data integrity and flexible data transmission through multiple paths. To this end, the PDCP may perform data integrity functions as being split into PDCP-C (PDCP-central) and PDCP-D (PDCP-distribute).

Meanwhile, the multi-PDCP-based cluster may require data management according to the applied multi-connectivity technology to ensure data integrity in a multi-connectivity environment. In addition, duplicate data transmission and reordering and sequencing of received data may be required for radio access points of the multi-PDCP-based cluster.

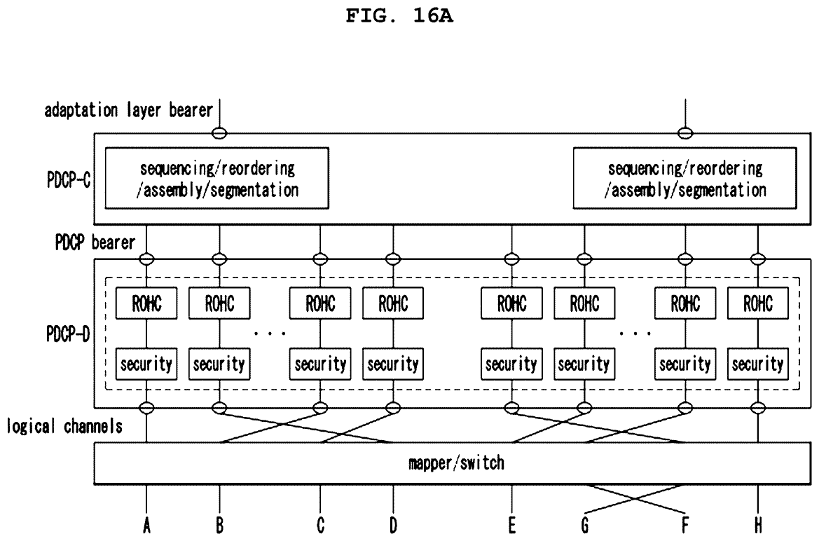

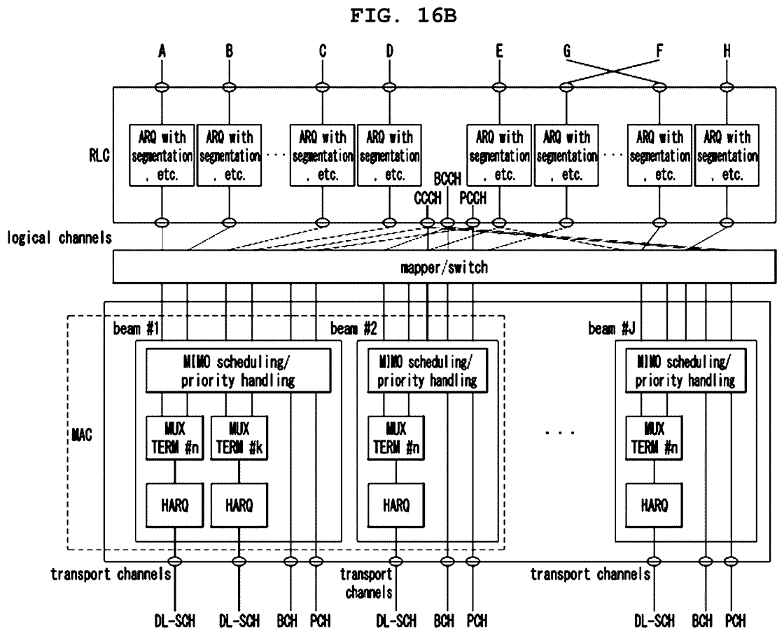

FIGS. 16A and 16B are conceptual diagrams illustrating a multi-PDCP-based cluster structure for ensuring the integrity of large-volume data.

In order to ensure data integrity in a multi-connectivity environment, data management according to the applied multi-connectivity technology may be required, and data redundancy transmission through radio access points, as well as reordering and sequencing of received data, may be required.

For data to be transmitted through multiple radio access points, protocol entities at each layer may need to be flexibly joined. Accordingly, the L2 layer may require flexible bearer and channel management. At this time, retransmission for data integrity may be performed at the cluster level under the instruction of the central control station. To this end, the L2 layer may manage logical channel information in each entity and transmit the corresponding PDU information.

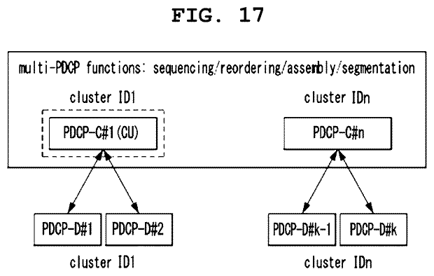

FIG. 17 is a conceptual diagram illustrating a multi-PDCP structure.

Referring to FIG. 17, PDCP-C entities (PDCP-C #1 to PDCP-C #n) located in the CU may be connected to multiple PDCP-D entities (PDCP-D #1 to PDCP-D #k) located in the DU, and may be redundantly cross-connected. The PDCP-D entities (PDCP-D #1 to PDCP-D #k) may only perform the function of controlling individual IP data among the functions of the PDCP layer. The PDCP-C entities (PDCP-C #1 to PDCP-C #n) may perform reordering, sequencing, aggregating, and splitting of the controlled IP packets. These PDCP-C entities (PDCP-C #1 to PDCP-C #n) can reduce L2 header overhead through IP data aggregation at the PDCP layer. Here, n and k may be positive integers.

In this case, PDCP groups may be identified by cluster identifiers. For example, PDCP-C #1, PDCP-D #1, and PDCP-D #2 may be identified by cluster ID 1. Similarly, PDCP-C #n, PDCP-D #k-1, and PDCP-D #k may be identified by cluster ID n. When the cluster is reconfigured, Branching to the PDCP-C may be performed through the cluster identifier composed of the CU-DU combination, so that L2 header overhead may be reduced through IP data aggregation at the PDCP layer.

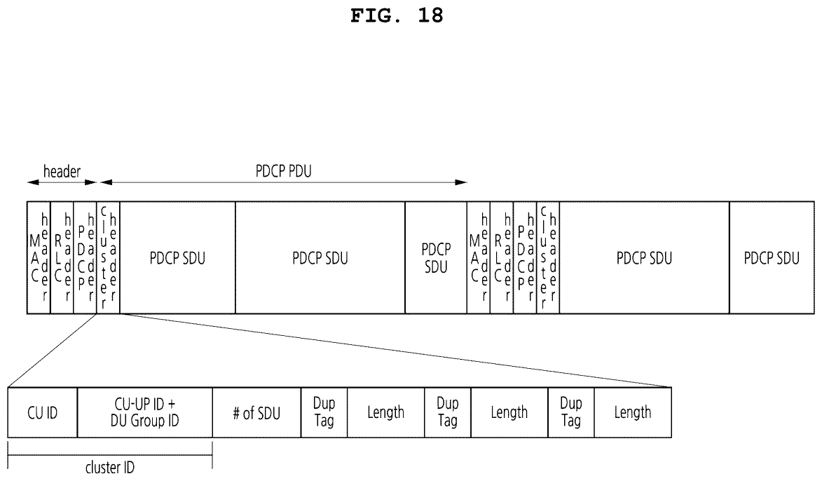

FIG. 18 is a structural diagram illustrating a multi-PDCP-based PDU.

Referring to FIG. 18, in a multi-PDCP-based system, each PDCP PDU may include multiple PDCP SDUs and may include a cluster header.

To reduce the header overhead at the L2 layer, the PDCP-C layer can concatenate IP packets that share the same Quality of Service (QoS) flow to form a single PDCP SDU.

The cluster header, as illustrated in FIG. 18, may comprise a cluster identifier and PDCP SDU information.

The cluster identifier may include the identifier of the Central Unit (CU ID) and information for identifying one or more Distributed Unit (DU) groups that constitute the cluster. For example, the information for identifying one or more DU groups that constitute the cluster may include the identifiers of each CU-UP and each DU group that constitute the cluster, as illustrated in FIG. 18 (CU-UP ID+DU Group ID). The PDCP PDU may be branched to the PDCP-C through the cluster identifier.

The PDCP SDU information included in the cluster header may include the number of SDUs included in the given PDCP PDU (# of SDU), a duplication transmission tag (Dup tag) indicating whether the SDU is transmitted redundantly, and length information (Length) of the SDU. Through this PDCP SDU information, control information for the PDCP-C may be configured. This approach may reduce the L2 header overhead per IP packet, thereby increasing transmission capacity during large-volume transmissions.

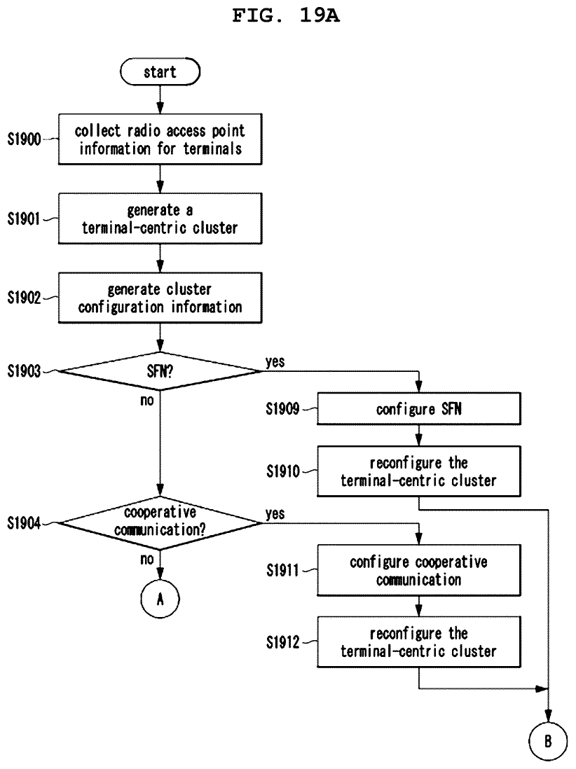

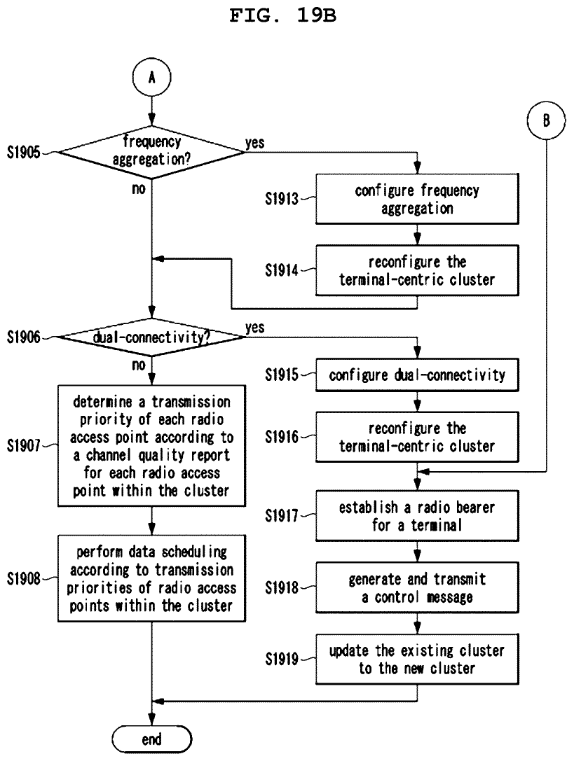

FIG. 19A and FIG. 19B are flowcharts illustrating a data transmission method for a high-capacity transmission network.

Referring to FIG. 19A and FIG. 19A, in the data transmission method for a high-capacity transmission network, terminals may measure channel reception strengths, channel qualities, transmission delays, and other parameters for surrounding radio access points. The terminals may then transmit radio access point information, including the channel reception strengths, channel quality information, and transmission delays measured for each radio access point, to a central control station. At this time, the terminals may distinguish radio access points using identifiers and transmit the information on the channel reception strength, channel qualities, and transmission delays for each to the central control station. Consequently, the central control station may receive and collect radio access point information from the terminals (S1900). Accordingly, the central control station may identify the identifiers of radio access points surrounding the terminals and determine the channel reception strength, channel quality, transmission delay, and other parameters for each radio access point.

Subsequently, the central control station may form a terminal-centric cluster with radio access points that have channel reception strengths equal to or greater than a threshold for each terminal (S1901). At this time, the central control station may generate and assign a cluster identifier to the terminal-centric cluster. Then, the central control station may collect information about the radio access points constituting the terminal-centric cluster and generate cluster configuration information (S1902).

In some embodiments, the cluster configuration information may include at least some of the following: a cluster identifier; information for identify the entities that constitute the terminal-centric cluster (e.g., radio access points, DUs, CU-UPs, CU-CPs, etc.); channel reception strength information; channel quality information; transmission delay information; and information regarding the frequency ranges used by each radio access point.

Accordingly, the central control station may determine whether SFN is applicable by reconfiguring the terminal-centric cluster with radio access points using the same frequency range (S1903).

As a result of the determination, if SFN is applicable because there are no obstacles between the radio access points using the same frequency band and the terminal and thus a possibility that multiple paths are generated is low, the central control station may configure SFN by coordinating configuration information of the corresponding radio access points in order to apply SFN (S1909). Then, the central control station may reconfigure the terminal-centric cluster with the radio access points participating in SFN and DUs connected to the corresponding radio access points (S1910). Then, the central control station may establish a radio bearer for the terminal (S1917), generate a control message informing information on the radio access points participating in SFN, and transmit it to the terminal through the established radio bearer (S1918). Accordingly, the terminal may prepare to apply SFN by receiving information on the radio access points participating in SFN through the established radio bearer.

Meanwhile, after transmitting the control message to the terminal, the central control station may update the existing terminal-centric cluster to the new terminal-centric cluster at a certain point in time, and provide communication services to the terminal using the updated terminal-centric cluster (S1919).

On the other hand, based on the determination of S1903, if SFN is not applicable because there are obstacles between the radio access points using the same frequency band and the terminal and thus a possibility that multiple paths are generated is high, the central control station may determine whether cooperative communication is applicable (S1904). If the cooperative communication is applicable as a result of the determination, the central control station may configure cooperative communication by coordinating the configuration information of the corresponding radio access points to apply the JT-COMP or DPS-COMP technique (S1911).

Then, the central control station may reconfigure the terminal-centric cluster with the radio access points participating in the cooperative communication (S1912). Then, the central control station may establish a radio bearer for the terminal (S1917), generate a control message informing information on the radio access points participating in the cooperative communication, and transmit it to the terminal through the established radio bearer (S1918). Accordingly, the terminal may prepare to apply the cooperative communication by receiving information on the radio access points participating in the cooperative communication through the established radio bearer. Meanwhile, after transmitting the control message to the terminal, the central control station may update the existing terminal-centric cluster to the new terminal-centric cluster at a certain point in time, and provide communication services to the terminal using the updated terminal-centric cluster (S1919).

On the other hand, based on the determination of S1904, if it is difficult to apply SFN and cooperative communication because there are not enough radio access points with the same frequency range, the central control station may determine whether frequency aggregation (e.g. CA) is possible using radio access points using heterogeneous frequencies (S1905).

As a result of the determination, if frequency aggregation is possible, the central control station may configure frequency aggregation by coordinating the configuration information of the corresponding radio access points to apply the frequency aggregation (S1913). Then, the central control station may reconfigure the terminal-centric cluster with radio access points participating in the frequency aggregation (S1914). Then, the central control station may determine whether DC is possible using the radio access points to be used for frequency aggregation (S1906). If frequency aggregation is not applicable according to the result of the determination of the step S1905, the central control station may perform the step S1906.

When dual-connectivity is applicable as a result of the determination, the central control station may configure dual-connectivity by coordinating the configuration information of the corresponding radio access points in order to apply the dual-connectivity (S1915). Then, the central control station may reconfigure the terminal-centric cluster with the radio access points participating in the dual-connectivity (S1916). Then, the central control station may establish a radio bearer for the terminal (S1917), generate a control message informing information on the radio access points participating in the dual-connectivity, and transmit it to the terminal through the established radio bearer (S1918). Accordingly, the terminal may prepare to apply the dual-connectivity by receiving information on the radio access points participating in the cooperative communication through the established radio bearer. Meanwhile, after transmitting the control message to the terminal, the central control station may update the existing terminal-centric cluster to the new terminal-centric cluster at a certain point in time, and provide communication services to the terminal using the updated terminal-centric cluster (S1919).

On the other hand, if it is difficult to apply dual-connectivity as the result of the determination in the step S1906, the central control station may determine a transmission priority of each radio access point according to the channel quality reported for each radio access point within the cluster (S1907). Then, the central control station may allow the corresponding radio access points to transmit data to the terminal (S1908) by performing data scheduling according to the transmission priorities of the respective radio access points within the cluster.

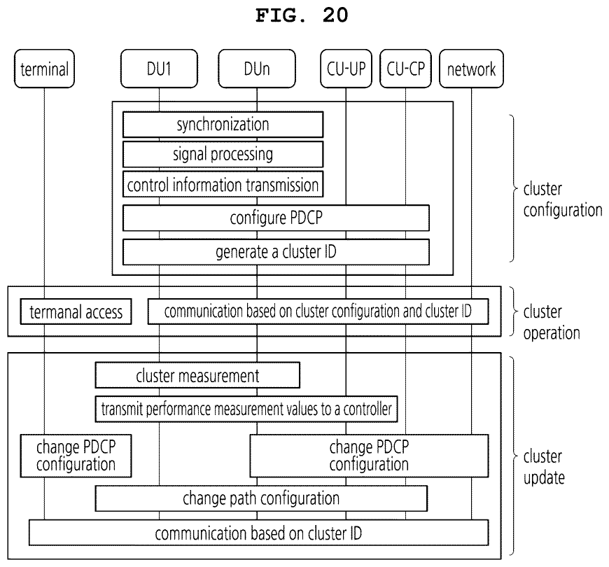

FIG. 20 is a conceptual diagram illustrating a method for operating a terminal-centric cluster.

Referring to FIG. 20, the operation of a terminal-centric cluster is performed under the control of a central control station and may comprise three stages: cluster configuration stage, cluster operation stage, and cluster update stage.

In some embodiments, the central control station may be included within the CU (Central Unit). In other embodiments, the central control station may exist separately from the CU. Hereinafter, embodiments assuming that the central control station is included within the CU will be described.

A cluster composed of multiple DUs (Distributed Units) or access points (RUs) may perform terminal access through a reference access point and may receive reports on wireless conditions.

In the cluster configuration stage, synchronization, signal processing, and control information transmission between DU 1 to DU n may be performed to configure the cluster. Additionally, in the cluster configuration stage, the central control station may configure the PDCP for cluster formation and generate a cluster identifier. For example, the cluster may be formed by registering a service access point group by the central control station.

In the cluster operation stage, terminal access, cluster configuration, and ID-based communication may be performed. For instance, after establishing links between access points and determining data flows, synchronization procedures may be performed. Once the reference access point is set up, the network and data transmission paths can be established by the existing access points, and cluster services may commence.

When a cluster is formed in a multi-connectivity situation, if the terminal receives a high-quality signal from an access point 1 set as a reference access point within the cluster, the terminal may receive control signals from Access Point 1 and perform data transmission and reception through the connected access point(s) among the protocol entities included in the configured cluster.

If the terminal moves within the area between access points 1 and 2, the related access point(s) and protocol entities may be activated. For example, if a terminal-specific signal is detected by access point 2, access point 2 may be activated. In this case, operations to split the data transmission path in the network and to decide whether to perform duplicate transmission or split transmission based on the access method may be performed under the instruction of the central control station.

If the communication link between the terminal and the access point 1 deteriorates due to terminal movement or other wireless condition changes, data transmission from the access point 1 to the terminal may be stopped, and the terminal may receive control and data from the access point 2 and related access points and protocol entities, and other access points and protocol entities on the cluster may transition to a standby state.

As the terminal moves toward access points 2, 3, and n, the corresponding access point may connect to the multi-connectivity access point already established through the previous access point using the protocol entity in the standby state.

When there is movement of the terminal within the cluster, communication may be maintained by changing the data transmission path without a separate control command. In this case, processes of deleting duplicate data and ordering data through the PDCP-C layer of the split PDCP layer's CU-UP may be performed, enabling sequential transmission and reception of data between the network and the terminal.

The reference access point may receive from a surrounding terminal, reports on the terminal's access capabilities and transmit them to the central control station. Consequently, the central control station may reconfigure the cluster, negotiate services for it to reconfigure the data transmission area. Once the data transmission area is reconfigured, the central control station may establish the scope and policies for cluster configuration and periodically receive access capability reports from the terminal to perform cluster update procedures.

The functional split base station may complete cluster configuration by configuring the PDCP based on synchronization between the CU and DUs, signal processing, control information transmission, and the cluster identifier. The functional split base station may operate the PDCP state based on the configured cluster, manage PDCP modes, and perform data communication.

Meanwhile, there may be instances where the cluster needs to be updated. In such cases, during the cluster update stage, the functional split base station may measure the cluster's performance and transmit the measurements to the central control station. The central control station may then receive the performance measurements and, based on these measurements, modify the PDCP configuration information for the terminal and DUs 1 to n. For example, the central control station may change the packet data configuration information to alter the packet data structure and modify PDCP paths and characteristics. Once the path configuration changes are complete, communication based on the updated cluster may be performed.

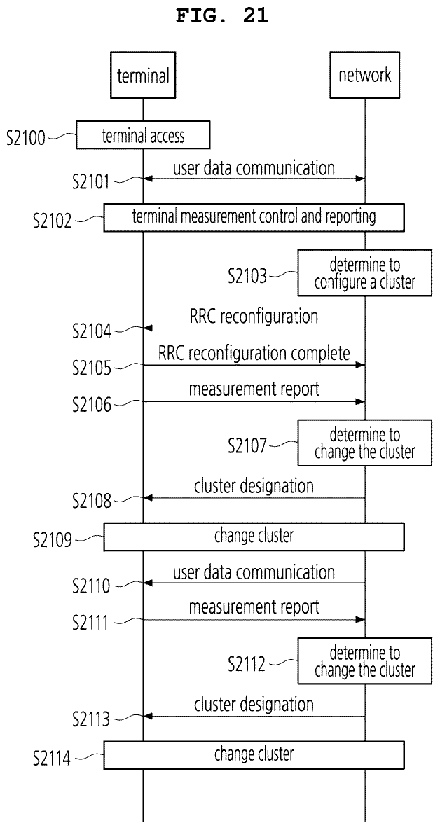

FIG. 21 is a conceptual diagram illustrating an example method for updating a terminal-centric cluster.

A connected terminal may periodically perform L1/L3 measurement reporting. When the network determines the cluster configuration, it may deliver the cluster configuration information to the terminal via an RRC reconfiguration message, thereby completing the cluster configuration. Based on this, the terminal may periodically perform cluster measurement reporting.

If a cluster change is determined based on the measurement reports, a cluster change procedure may be performed. Once the change is completed, the cluster configuration change may be finalized through an RRC Reconfiguration message.

Referring to FIG. 21, in the terminal-centric cluster update method, the terminal may perform terminal access to the network (S2100). Here, the network may be one or more radio access points 1 to n, a CU, etc. The terminal may transmit and receive user data to and from the network to perform user data communication (S2101). Subsequently, the terminal and the network may proceed with terminal measurement control and reporting procedures (S2102). For example, the connected terminal may periodically perform L1/L3 measurement reporting.

Meanwhile, through the terminal measurement reporting procedure, the network may decide to configure a cluster based on the information acquired for the terminal and radio access points 1 to n (S2103). Accordingly, the network may configure a cluster and complete the cluster configuration by transmitting an RRC reconfiguration message containing cluster configuration information to the terminal (S2104).

The terminal may receive the RRC reconfiguration message from the network and configure the RRC according to the received RRC reconfiguration message. Subsequently, the terminal may send an RRC reconfiguration completion message to the network (S2105).

Meanwhile, the terminal may transmit and receive data through radio access points of the cluster and perform measurements on the radio access points, transmitting the measurement reports to the network (S2106). For instance, the terminal may periodically perform measurements on surrounding radio access points and transmit the measurement results to the network. Then, the network may receive the measurement reports from the terminal and determine whether a cluster change is necessary. If the network determines that a cluster change is necessary, it may decide to change the cluster and perform the cluster change (S2107). The network may then transmit a cluster designation signal containing cluster change information to the terminal (S2108). Accordingly, the terminal receives the cluster designation signal, and the network can proceed with a cluster change procedure (S2109).

Then, the terminal may perform user data communication by transmitting and receiving user data to and from the network based on the changed cluster (S2110). Subsequently, the terminal may perform measurements on surrounding radio access points and transmit the measurement results as a measurement report to the network (S2111). The network may then receive the measurement report from the terminal and obtain the measurement information. If the network determines that a cluster change is necessary, it may decide to change the cluster and perform the cluster change (S2112). The network may transmit a cluster designation signal containing cluster change information to the terminal (S2113). Accordingly, the terminal may receive the cluster designation signal. The terminal and the network may proceed with a cluster change procedure (S2114).

The cluster change procedure may be completed by transmitting RRC reconfiguration-related messages.

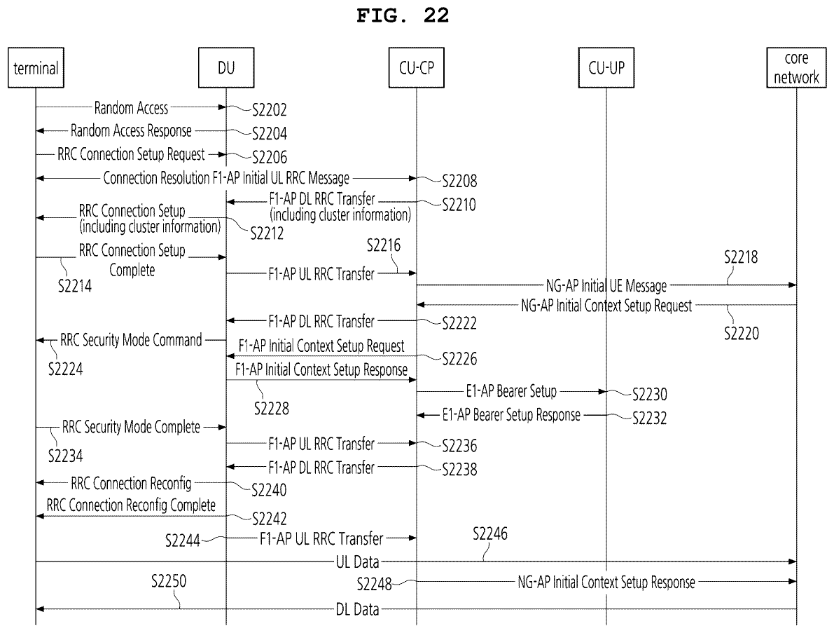

FIG. 22 is a conceptual diagram illustrating a message flow diagram for handling a functional split base station.

In some embodiments, the CU-CP may configure a cluster that provides multiple radio access points to a specific terminal based on at least one first DU among multiple DUs and at least one first CU-UP among multiple CU-UPs.

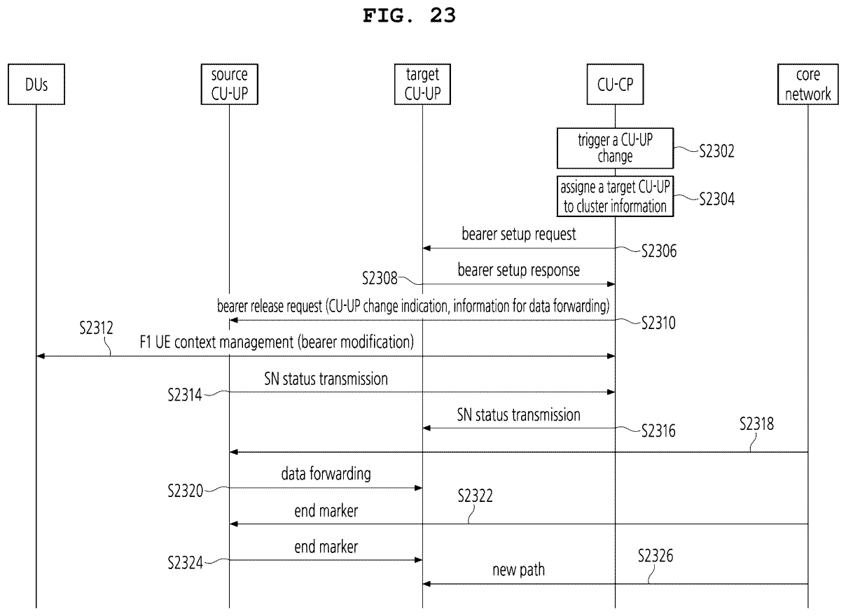

In some embodiments, the configured cluster may be updated as described below through FIG. 23 and others. For example, one of the at least one first CU-UP may be changed to a second CU-CP. Alternatively, one of the at least one first DU may be changed to a second DU. Another example is that the first CU-CP may be changed to a second CU-CP.

As illustrated in FIG. 22, the CU-CP may transmit cluster configuration information to the DU and the terminal through the RRC Connection Setup procedure.

The terminal may perform a random access procedure (S2202) and receive a random access response from the DU (S2204).

Based on the received random access response, the terminal may transmit an RRC Connection Request message to the DU (S2206). The RRC Connection Request message may include a CN UE temporary identifier.

The network may respond with an L2 competition resolution message and may transmit the UE's RRC message to the CU-CP through an F1AP Initial UL RRC Message (F1AP INITIAL UL RRC MESSAGE) (S2208).

In the L2 competition resolution message, the contents of the RRC Connection Request may be retransmitted to the terminal and may be transmitted before or after the transmission of the F1AP Initial UL RRC Message.

The F1AP Initial UL RRC Message (F1AP INITIAL UL RRC MESSAGE) may include additional information such as the F1AP UE identifier, the C-RNTI assigned to the UE, and lower layer configurations.

In some embodiments, the CU-CP may configure the cluster based on receiving the F1AP Initial UL RRC Message. For example, as illustrated in FIG. 22, if the CU-CP decides to accept the UE, it may generate an RRC Connection Setup message and transmit this message to the DU as an F1AP DL RRC Transfer message (S2210).

In some embodiments, the F1AP DL RRC Transfer message may include the RRC message and the F1AP UE identifier. The RRC message may include information received from the DU in the previous step.

In some embodiments, the F1AP DL RRC Transfer message may include cluster configuration information.

When the DU receives the DL RRC Transfer message, it may transmit the RRC Connection Setup message to the terminal (S2212). In some embodiments, the RRC Connection Setup message may include cluster configuration information received from the CU-CP.

Thus, the transmission of the DU's RRC Connection Setup message (S2212) and the terminal's response by transmitting an RRC Connection Setup Complete message (S2214) may establish an RRC connection wirelessly.

If the DU receives the terminal's RRC Connection Setup Complete message, it may relay the corresponding RRC message to the CU-CP (S2216). The relayed RRC message may include NAS information, CN node selection, and slicing information.

The CU-CP may transmit an NGAP Initial UE Message to the 5GC (5G Core Network) (S2218).

If the 5GC determines to set up the UE context, it may transmit an NGAP Initial Context Setup Request (NGAP INITIAL CONTEXT SETUP REQUEST) (S2220). At this point, the RAN may receive the UE context and may start multiple procedures, some of which may occur in parallel.

The procedures in steps S2222, S2224, S2234, and S2236 may trigger UE security configuration through a security mode command procedure. From this point onward, subsequent wireless signals or data may be encrypted, and signal integrity can be protected. Steps S2222, S2224, S2234, and S2236 may be performed in parallel with steps S2226, S2228, S2230, and S2232.

The procedures in steps S2226, S2228, S2230, and S2232 may relate to resource configurations of the DU and CU-UP for a specific terminal. In the procedure flow, the CU-CP may first transmit an F1AP UE Context Setup Request to the DU, receive an F1AP UE Context Setup Response, and then set up a bearer at the CU-UP.

The CU may generate an RRC Connection Reconfiguration message and transmit it to the DU (S2238). Step S2238 may be performed after steps S2226 and S2228 because the RRC message includes lower layer configurations of the DRB provided by the DU. Step S2238 may occur before steps S2236 and S2238.

A RRC Reconfiguration procedure that includes the transmission of the DU's RRC Connection Reconfiguration message (S2240) and the terminal's transmission of an RRC Connection Reconfiguration Complete message (S2242) may be performed.

After the RRC Reconfiguration procedure is completed, uplink data transmission may commence.

The DU may encapsulate the RRC message into an F1AP UL RRC Message Transfer message and transmit it to the CU-CP (S2244).

The CU-CP may approve the 5GC's context setup request and provide a GTP TEID for the CU-UP to the 5GC (S2248).

FIG. 23 illustrates an message flow diagram for the CU-UP change procedure in a functional split base station.

As illustrated in FIG. 23, the CU-CP may manage multiple CU-UPs. In some embodiments, the CU-CP may alter the DU transmission area by changing the CU-UP data transmission path. This may facilitate terminal mobility.

In some embodiments, when the CU-CP determines a CU-UP change, it may assign a target CU-UP to the corresponding cluster configuration information, perform bearer setup procedures (S2306, S2308) for the target CU-UP, and perform bearer release procedures (S2310) for the source CU-UP. Additionally, in some embodiments, the CU-CP may notify the source CU-UP of the CU-CP change through the bearer release procedure.

Under the control of the CU-CP, the DU may clean up the UE context corresponding to the bearer modification. Subsequently, the path change may be finalized through SN status transmission, data forwarding, and end marker transmission, thereby establishing a new path.

Referring to FIG. 23, a CU-UP change may be triggered at the CU-CP (S2302).

The CU-CP may assign a target CU-UP for the CU-UP change to the cluster configuration information (S2304). In step S2304, the CU-CP may assign an UL TEID for the F1-U used in the target CU-UP to receive UL user data from the DU.

The CU-CP may transmit an E1AP Bearer Setup Request message to the target CU-UP to set up one or more bearers in the target CU-UP (S2306).

The target CU-UP may respond to the CU-CP with an E1AP Bearer Setup Response message to confirm the bearer setup (S2308).

The CU-CP may transmit an E1AP Bearer Release Request message, including a CU-UP change indication, to the source CU-UP to initiate procedures for releasing one or more bearers in the source CU-UP (S2310). A TEID for data forwarding may be included in the E1AP Bearer Release Request message.

An F1 UE context management procedure may be performed in the DU to modify one or more bearers (S2312).

An SN status transmission procedure may be performed (S2314, S2316).

Data forwarding from the source CU-UP to the target CU-UP may be performed (S2320).

A path update procedure (S2320, S2322, S2324) may be performed to update the DL TEID directed toward the core network. Upon receiving an end marker packet, the source CU-UP may release resources allocated to the UE.

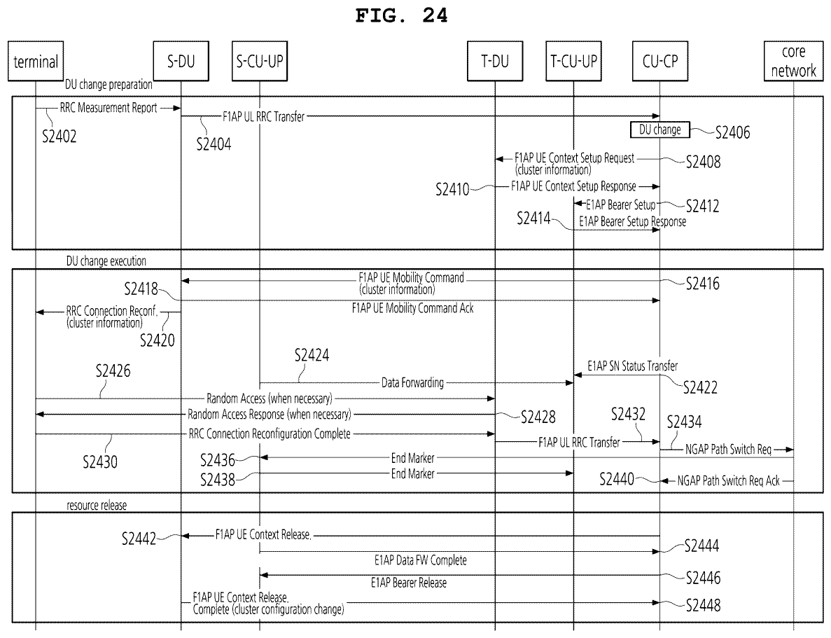

FIG. 24 is a conceptual diagram illustrating a message flow diagram for the DU change procedure in a functional split base station.

As illustrated in FIG. 24, the DU change procedure may be divided into three phases: DU change preparation phase, DU change execution phase, and resource release phase.

In the DU change preparation phase, as shown in FIG. 24, when a DU belonging to the same CU-CP area is to be changed, a bearer setup procedure for the target CU-UP (T-CU-UP) may be performed. In some embodiments, the CU-CP may transmit cluster configuration information during the UE context setup request procedure and perform the corresponding bearer setup procedure. In some embodiments, the target CU-CP (T-CU-CP) may transmit cluster configuration information to the target DU (T-DU) in the DU change preparation phase.

In the DU change execution phase, procedures for connecting to the target DU and changing the data path may be performed. In some embodiments, the terminal may receive updated cluster configuration information through an RRC connection reconfiguration message sent via the source DU (S-DU) and perform a data transmission path change procedure accordingly.

In the resource release phase, resources of the source DU (S-DU) may be released, and the DU change procedure may be completed. In some embodiments, once the path change is completed, the source DU (S-DU) may release allocated resources and finalize the cluster release and change procedure through a UE context release procedure.

Referring to FIG. 24, the DU change procedure may be initiated when the terminal transmits an RRC measurement report to the source DU (S-DU) (S2402). In some embodiments, the event that triggers the measurement report may vary depending on the measurement configuration of the terminal.

The source DU (S-DU) may forward the RRC measurement report to the source CU-CP (S-CU-CP) via F1AP UL RRC transfer (S2404).

In some embodiments, the CU-CP may decide to change the DU based on receiving the F1AP UL RRC transfer message corresponding to the device's RRC measurement report (S2406). The DU change decision may be based on information included in the measurement report in some embodiments.

The CU-CP may transmit an F1AP context setup request message to the target DU (T-DU) (S2408). In some embodiments, the F1AP context setup request message may include cluster configuration information.

The target DU (T-DU) may transmit an F1AP context setup response message to the CU-CP (S2410).

The CU-CP may transmit an E1AP bearer setup message to the target CU-UP (T-CU-UP) (S2412).

The target CU-UP (T-CU-UP) may transmit an E1AP bearer setup response message to the CU-CP (S2414).

Referring to FIG. 24, to start the DU change execution phase, the CU-CP may transmit an F1AP UE mobility command to the source DU (S-DU) (S2416). In some embodiments, the F1AP UE context mobility command may include cluster configuration information.

The source DU (S-DU) may transmit an F1AP UE mobility command response to the CU-CP to confirm that the DU change has been accepted (S2418).

The source DU (S-DU) may transmit an RRC reconfiguration message to the terminal (S2420). In some embodiments, the RRC reconfiguration message may include cluster configuration information.

The CU-CP may transmit an E1AP SN status transfer message to the target CU-UP (T-CU-UP) (S2422).

The source CU-UP (S-CU-UP) may perform data forwarding to the target CU-UP (T-CU-UP) (S2424).

The terminal may perform random access if necessary (S2426). For this, the terminal may transmit a random access preamble to the target DU (T-DU). The terminal may use a dedicated RACH preamble if included in the RRC reconfiguration message, but the scope of the embodiment is not limited thereto.

The target DU (T-DU) may transmit a random access response to the terminal (S2428).

The terminal may transmit an RRC connection reconfiguration complete message to the target DU (T-DU) (S2430).

The target DU (T-DU) may forward the RRC connection reconfiguration complete message to the CU-CP using an F1AP UL RRC transfer message (S2432).

After receiving the F1AP UL RRC transfer, the CU-CP may transmit an NGAP path switch request message to the core network (e.g., AMF) to indicate that the terminal has changed DUs (S2434).

The core network, such as the AMF, may then need to contact the UPF to modify the PDU session.

The core network (e.g., UPF) may transmit an “end marker” packet to the source CU-UP (S-CU-UP) (S2436).

Upon receiving the “end marker” packet, the source CU-UP (S-CU-UP) may forward the “end marker” packet to the target CU-UP (T-CU-UP) if forwarding is applied (S2438).

The core network (e.g., AMF) may acknowledge the NGAP path switch request message with an NGAP path switch request acknowledge message (S2440).

Referring to FIG. 24, to start the resource release phase, the CU-CP may transmit an F1AP UE context release message to the source CU-CP (S-CU-CP) (S2442). The F1AP UE context release message may inform the source CU-CP (S-CU-CP) that the DU change has been successful.

The source CU-UP (S-CU-UP) may transmit an E1AP Data forwarding complete message to the CU-CP (S2444). In response, the CU-CP may transmit an E1AP Bearer Release message to the source CU-UP (S-CU-UP) to release the DRB and release the corresponding resources (S2446).

The source DU (S-DU) may release the UE context and respond to the CU-CP with an F1AP UE context release complete message (S2448). Through the F1AP UE context release complete message, the source DU (S-DU) may inform the CU-CP that the cluster configuration change has been completed.

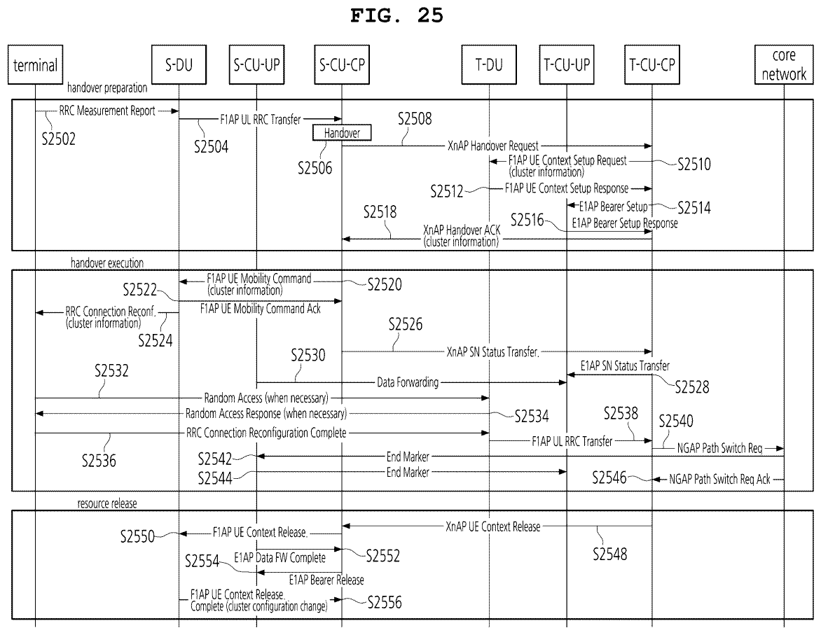

FIG. 25 illustrates a handover procedure message flow in a multi-functional split base station.

The handover procedure may be divided into handover preparation, handover execution, and resource release phases, as shown in FIG. 25.

In the handover preparation phase, a bearer setup procedure for the target base station may be performed through the terminal's measurement report. In some embodiments, the target CU-CP may transmit cluster configuration information during the UE context setup request procedure and perform the corresponding bearer setup procedure. In some embodiments, the target CU-CP may transmit cluster configuration information to the source CU-CP during the handover preparation phase.

In the handover execution procedure, access to the target DU and data path change procedures may be performed. In some embodiments, the terminal may receive updated cluster configuration information through an RRC Connection Reconfiguration message via the source DU and perform the data transmission path change procedure accordingly.

In the resource release phase, the source DU's resources may be released, and the handover procedure may be completed. In some embodiments, once the path change is complete, the source DU may release allocated resources and finalize the cluster release and change procedure through the UE Context Release procedure.

Referring to FIG. 25, to initiate the handover preparation phase, the terminal may transmit an RRC measurement report to the source DU (S-DU) (S2502). The event triggering the measurement report may vary depending on the terminal's measurement configuration.

The source DU (S-DU) may forward the RRC measurement report to the source CU-CP (S-CU-CP) using an F1AP UL RRC transfer message (S2504).

The source CU-CP (S-CU-CP) may make a handover decision based on the contents of the RRC measurement report (S2506).

The source CU-CP (S-CU-CP) may transmit an XnAP handover request message to the target CU-CP (T-CU-CP) to provide necessary information for preparing the handover (S2508).

In some embodiments, the target CU-CP (T-CU-CP) may decide to update the cluster for the corresponding terminal based on the received XnAP handover request. For example, the target CU-CP (T-CU-CP) may perform admission control, create a UE context, identify the target DU (T-DU), and select the target CU-UP (T-CU-UP). The target CU-CP (T-CU-CP) may then transmit an F1AP context setup request message to the target DU (T-DU), including UE context information and CU-UP-UL-TEID for the Data Radio Bearer (DRB) (52510). The F1AP context setup request may include cluster configuration information for the updated cluster.

The target DU (T-DU) may perform admission control, configure lower layers, and create a local UE context. The target DU (T-DU) may then transmit an F1AP context setup response message to the target CU-CP (T-CU-CP), including lower layer configuration, C-RNTI, and DU-DL-TEID for the DRB (S2512).

The target CU-CP (T-CU-CP) may transmit an E1AP bearer setup message to the target CU-UP (T-CU-UP), including information on security setup and QoS flow to DRB mapping (S2514).

After applying the configuration received from the target CU-CP (T-CU-CP), the target CU-UP (T-CU-UP) may transmit an E1AP BEARER SETUP RESPONSE message to the target CU-CP (T-CU-CP) (S2516).

The target CU-CP (T-CU-CP) may transmit an XnAP handover request acknowledge message to the source CU-CP (S-CU-CP) (S2518). The XnAP handover request acknowledge message may include cluster configuration information for the updated cluster.

Referring to FIG. 25, to initiate the handover execution phase, the source CU-CP (S-CU-CP) may transmit an F1AP UE mobility command to the source DU (S-DU) (S2520). In some embodiments, the F1AP UE mobility command may include cluster configuration information for the updated cluster.

In some embodiments, the F1AP UE mobility command message may include a transparent container carrying an RRC message to perform the handover. This RRC message may be generated by the target CU-CP (T-CU-CP) and encrypted and integrity protected by the source CU-CP (S-CU-CP). The F1AP UE mobility command message may include specific field values notifying the source DU (S-DU) about the handover.

The source DU (S-DU) may transmit an F1AP UE mobility command acknowledge message to the source CU-CP (S-CU-CP) to confirm that the handover has been accepted (S2522). The F1AP UE mobility command acknowledge message may include information on the transmission status of PDCP PDUs.

The source DU (S-DU) may transmit an RRC connection reconfiguration message to the terminal (S2524). In some embodiments, the RRC connection reconfiguration message may include cluster configuration information for the updated cluster.

The source CU-CP (S-CU-CP) may transmit an XnAP SN Status transfer message to the target CU-CP (T-CU-CP) to convey the uplink PDCP SN receiver status and downlink PDCP SN transmitter status (S2526).

The target CU-CP (T-CU-CP) may transmit an E1AP SN status transfer message to the target CU-UP (T-CU-UP) to convey the uplink PDCP SN receiver status and downlink PDCP SN transmitter status (S2528).

Data forwarding from the source CU-UP (S-CU-UP) to the target CU-UP (T-CU-UP) may begin (S2530).

The terminal may perform random access if necessary (S2532). For this, the terminal may transmit a random access preamble to the target DU (T-DU).

The target DU (T-DU) may transmit a random access response to the terminal (S2534).

The terminal may transmit an RRC connection configuration complete message to the target DU (T-DU) (S2536).

The target DU (T-DU) may use an F1AP UL RRC transfer message to forward the RRC Connection Reconfiguration Complete message to the target CU-CP (T-CU-CP) (S2538).

The target CU-CP (T-CU-CP) may transmit an NGAP path switch request message to the core network (e.g., AMF) to notify that the terminal has changed cells (S2540). The AMF in the core network may then need to contact the UPF to modify the PDU session.

The core network (e.g., UPF) may transmit an “end marker” packet to the source CU-UP (S-CU-UP) (S2542).

Upon receiving the “end marker” packet, the source CU-UP (S-CU-UP) can forward it to the target CU-UP (T-CU-UP) if forwarding is applied (S2544).

The core network (e.g., AMF) may acknowledge the NGAP path switch request message with an NGAP path switch request acknowledge message (S2546).

Referring to FIG. 25, to initiate the resource release phase, the target CU-CP (T-CU-CP) may transmit an XnAP UE context release message to the source CU-CP (S-CU-CP) (S2548). The XnAP UE context release message may notify the source CU-CP (S-CU-CP) that the handover was successful.

The source CU-CP (S-CU-CP) may transmit an F1AP UE context release message to the source DU (S-DU), allowing the source DU (S-DU) to release resources allocated to the terminal (S2550).

The source CU-UP (S-CU-UP) may transmit an E1AP data forward complete message to the source CU-CP (S-CU-CP) as soon as data forwarding to the target CU-UP (T-CU-UP) is complete (S2552).

The source CU-CP (S-CU-CP) may transmit an E1AP bearer release message to the source CU-UP (S-CU-UP) to release the DRB and release corresponding resources (S2554).

The source DU (S-DU) may release the UE context and respond to the source CU-UP (S-CU-UP) with a UE context release complete message (S2556)

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random-access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above-described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

What is claimed is:

1. A method of operating a first central unit-control plane (CU-CP) implemented by an electronic device in a functional split base station system comprising a plurality of distributed units (DUs), a plurality of central unit-user planes (CU-UPs), and at least one CU-CP, the method comprising:
configuring a cluster that provides a plurality of radio access points to a specific terminal based on at least one first DU among the plurality of DUs and at least one first CU-UP among the plurality of CU-UPs; and
providing cluster configuration information for the configured cluster to at least one of the at least one first DU and the at least one first CU-UP.

2. The method of claim 1,
wherein configuring the cluster comprises, in response to receiving from one of the plurality of DUs an F1 Application Protocol (F1AP) initial uplink (UL) Radio Resource Control (RRC) message corresponding to an RRC connection setup request message of the specific terminal, configuring the cluster;
and wherein the at least one first DU includes the DU that transmitted the F1AP initial UL RRC message.

3. The method of claim 2, wherein providing the cluster configuration information comprises providing the cluster configuration information to the DU that transmitted the F1AP initial UL RRC message via an F1AP downlink (DL) RRC transfer message.

4. The method of claim 3, wherein the DU that transmitted the F1AP initial UL RRC message transmits an RRC connection setup message including the cluster configuration information to the specific terminal.

5. The method of claim 1, further comprising updating the cluster by changing one of the at least one first CU-UP to a second CU-UP.

6. The method of claim 5,
wherein updating the cluster comprises performing a bearer setup procedure for the second CU-UP.

7. The method of claim 5, wherein updating the cluster comprises notifying a CU-CP change to one of the at least one first CU-UP via a bearer release procedure.

8. The method of claim 1, further comprising updating the cluster by changing one of the at least one first DU to a second DU.

9. The method of claim 8,
wherein updating the cluster comprises updating the cluster in response to receiving, from one of the at least one first DU, an F1AP UL RRC transfer message corresponding to an RRC measurement report of the terminal.

10. The method of claim 8, wherein updating the cluster comprises providing the cluster configuration information for the updated cluster to the second DU via an F1AP UE context setup request.

11. The method of claim 8, wherein updating the cluster comprises providing the cluster configuration information for the updated cluster to one of the at least one first DU via an F1AP UE mobility command, so that the one of the at least one first DU provides the cluster configuration information to the specific terminal.

12. The method of claim 8,
wherein updating the cluster comprises releasing the resources allocated to the at least one first DU when the change from one of the at least one first DU to the second DU is completed.

13. The method of claim 1, wherein configuring the cluster comprises configuring the cluster in response to receiving an Xn Application Protocol (XnAP) handover request from a second CU-UP that is responsible for the previously configured cluster for the specific terminal.

14. The method of claim 13, wherein providing the cluster configuration information comprises providing the cluster configuration information to the second CU-CP via an XnAP handover acknowledgment (ACK), so that the second CU-CP provides the cluster configuration information to the second DU that is the included in the previously configured cluster and managed by the second CU-CP.

15. The method of claim 14, wherein the second DU provides the provided cluster configuration information to the specific terminal via an RRC connection reconfiguration message.

16. The method of claim 1, wherein the cluster configuration information includes information for identifying the at least one first DU and the at least one first CU-UP.

17. The method of claim 1,
wherein a Packet Data Convergence Protocol (PDCP) Protocol Data Unit (PDU) used in the functional split base station system includes a PDCP header, a cluster header, and at least one PDCP Service Data Unit (SDU),
wherein the cluster header includes a cluster identifier; and
wherein the cluster identifier includes a CU-CP identifier, a CU-UP identifier, and an identifier for a DU group.

18. The method of claim 1,
wherein the PDCP PDU used in the functional split base station system includes a PDCP header, a cluster header, and at least one PDCP SDU, wherein the cluster header includes the number of the at least one PDCP SDU, a tag indicating whether each of the at least one PDCP SDU is a duplicate transmission, and length information for each of the at least one PDCP SDU.

19. The method of claim 18,
wherein the first CU-CP performs IP data aggregation at the PDCP layer based on the cluster header.

20. An electronic device performing a CU-CP in a functional split base station system comprising a plurality of DUs, a plurality of CU-UPs, and at least one CU-CP, the electronic device comprising:
a processor;
at least one hardware-based transceiver; and
a computer-readable storage medium including instructions,
wherein the instructions, when executed by the processor, cause the electronic device to perform the method of claim 1.
